(19) United States
(12) Patent Application Publication
(10) Pub. No.: US 2026/0080221 A1
(43) Pub. Date: Mar. 19, 2026

(54) CORRECTING GENERATIVE LANGUAGE MODEL HALLUCINATIONS USING SEMANTIC REPLACEMENT

(71) Applicant: Shopify Inc., Ottawa (CA)

(72) Inventors: Kshetrajna Raghavan, Fremont, CA (US); Niklas Itänen, Ottawa (CA); Peng Yu, Montreal (CA); Diego Fernando Castaneda Perez, Toronto (CA); Isaac Vidas, Medford, MA (US)

(21) Appl. No.: 18/886,290

(22) Filed: Sep. 16, 2024

(51) Int. Cl. G06N 3/0475; G06N 3/0455; G06N 3/096

(52) U.S. Cl. CPC G06N 3/0475; G06N 3/0455; G06N 3/096

(57) ABSTRACT

A generative language model, such as an LLM, may “hallucinate,” such that it provides an output category that is incorrect or not relevant to its input. One solution is to use semantic replacement after the generative language model finishes outputting the category. A prompt may be provided to a generative language model, the prompt instructing the generative language model to generate output that classifies an input to the generative language model. Output may be received from the generative language model, the output classifying the input into a category. It may be determined that the category is an invalid category. A valid category be obtained based on the invalid category. The invalid category may be substituted with the valid category.

### FIELD

The present application relates to generative language models that utilize machine learning, such as large language models (LLMs), and more particularly to correcting hallucination in output from those generative language models.

### BACKGROUND

In machine learning, a generative model is a model that utilizes machine learning to generate content, such as text or images, e.g. in response to an input prompt. A generative model may sometimes be referred to as generative artificial intelligence (AI). An example of a generative model is a generative language model, such as a large language model (LLM). An LLM generates language, typically in the form of text in response to an input prompt. An LLM may utilize a large neural network to determine probabilities for a next token of a sequence of text conditional on previous or historical tokens in the sequence of text.

### SUMMARY

Generative language models, such as large language models (LLMs), may be prompted with an input to classify into a category. The input may be text, an image or some combination of input types. Assume, for the sake of example, the input to an LLM includes an image of a video game controller. The prompt of the LLM may instruct the LLM to categorize what is in the image. The output category generated by the LLM responsive to the prompt may, for example, be as follows: “Electronics>Electronic Accessories>Computer Components>Input Devices>Game Controllers>Game System Controller”. However, this output category may be invalid because the LLM has hallucinated. In particular, there may be limitations on what categories or sub-categories can be valid categories, e.g. it may be that only “System Controllers” is a valid sub-category, such that the node or substring “Game System Controller” in the LLM's output is invalid. Rather, the correct node or substring would be “System Controllers”. Hallucination is a technical problem that can occur because of factors such as overfitting or underfitting, e.g. stemming from incomplete or not enough training or fine-tuning of the LLM.

One method of addressing this problem may be to enforce a grammar at the LLM's output as it generates each token to limit output only to valid strings. However, implementing these grammars may be computationally expensive. For example, in situations where the category is hierarchical, the raw grammar file may first need to be formulated as a finite state machine having many states and transitions corresponding to all permutations of allowable output before the LLM can begin using the grammar, consuming significant computational resources. Also, enforcing the grammar requires computational resources and adds latency, but in some cases it may provide only limited benefit because the LLM may also generate a valid category in the absence of grammar enforcement. The grammar enforcement may provide a significant benefit if the LLM hallucinates, but it is not known in advance whether or not the LLM will hallucinate, and so the grammar enforcement is always applied.

In addition, even if the computational expense is affordable, once the grammar constrains the output to begin traversing a certain hierarchical path, e.g. “Electronics>Computer Hardware,” the LLM will be limited to that path only. That is, the grammar-constrained LLM is not able to go back and revise previous tokens, such as replacing “Computer Hardware” with “Electronic Accessories” to attempt a different hierarchical path. Thus, although hallucination by the LLM may be limited by constraining its output with a grammar, there is no way for the grammar or the LLM itself to ensure that the LLM still generates the correct category as output once it has made a hierarchical misstep, even if that misstep is to a valid category or sub-category.

In addition to the problems discussed above, grammar enforcement is not supported by some LLMs.

As well, query-response systems may include an LLM which is prompted with a user query. The LLM may be configured to respond to the user query with one or more predefined answers. However, in some cases the LLM may still hallucinate and generate a response that is not included within the predefined answers. The same limitations of grammar enforcement discussed above may also apply to this query-response system.

One possible solution to these problems is to use a semantic replacement method after the LLM finishes outputting the category.

As a first step, the semantic replacement method determines whether the category output by the LLM is invalid. This may involve comparing the output category to a plurality of valid categories, such as valid categories stored in a database. If the output category matches (or is sufficiently similar to, in some examples) a valid category, the method does not need to proceed because the output category is already valid.

However, if the output category does not match (or sufficiently match) a valid category, the output is an invalid category and the method may proceed to the second step. The second step includes obtaining a valid category that is similar to or related (e.g. most related) to the invalid category output by the LLM.

Once the valid category has been obtained, the method may proceed to the third step. The third step includes replacing the invalid category output by the LLM with the valid category.

In some examples, the method may determine whether the output category matches a valid category by embedding the output category, i.e. generating an embedding vector corresponding to the output category. The embedding corresponding to the output category may then be compared to reference embeddings corresponding to the valid categories. The reference embeddings and/or valid categories may be stored in a database. If the embedding corresponding to the output category matches one of the reference embeddings (or is sufficiently similar to one of the reference embeddings, in some examples), then the method may determine that the output category is valid. However, if no match is found, the method may instead determine that the output category is invalid. In other examples, embedding is not used to determine whether the output category is valid, e.g. the text of the output category may be directly compared to text of valid categories to determine if there is a match.

The embeddings may also or instead be used to obtain a valid category that is related to the invalid category output by the LLM. In one example, after comparing the reference embeddings to the embedding corresponding to the invalid category, the most related reference embedding may be determined and its corresponding valid category may be selected. This comparison may be performed using at least one of: a vector search, k-nearest neighbour matching, approximate nearest neighbour search, cosine similarity, dot product and/or fuzzy search method.

In some examples, this method may be used to improve the accuracy of the LLM. The LLM may receive a prompt that instructs it to classify an input to the LLM. The LLM may output a category corresponding to the input. If the semantic replacement method determines that the category is invalid, this determination may indicate that the LLM is improperly trained (or not trained enough) on this type of input. The method may further determine what training data is required to fine tune the LLM based on at least one of: the valid category determined by the semantic replacement method, the invalid category, and/or the input to the LLM.

In some further examples, the method may instead or in addition include re-training the LLM using at least one of: the valid category determined by the semantic replacement method, the invalid category, the differential between the valid category and the invalid category, and/or the input to the LLM. Re-training the LLM may be or include fine-tuning (e.g. further fine-tuning) the LLM based on this additional data.

In some other examples, the category output by the LLM may include one or more sub-categories. The semantic replacement method may be used to determine whether only one or more of the sub-categories or substrings are invalid and, if the one or more sub-categories or substrings are invalid, to replace only those invalid sub-categories or substrings in the output category. In the example of the output category “Electronics>Electronic Accessories>Computer Components>Input Devices>Game Controllers>Game System Controller,” the semantic replacement method may only determine whether the last several sub-categories are invalid, such as “Input Devices>Game Controllers>Game System Controller” and replace those invalid sub-categories with the valid sub-categories “Input Devices>Game Controllers>System Controllers.”

In one aspect, there is provided a computer-implemented method. The method may include providing a prompt to a generative language model, the prompt instructing the generative language model to generate output that classifies an input to the generative language model. The method may further include receiving the output from the generative language model, the output classifying the input into a category. The method may further include determining that the category is an invalid category. The method may further include obtaining a valid category based on the invalid category. The method may further include substituting the invalid category with the valid category.

In some implementations, obtaining the valid category based on the invalid category may include: computing an embedding based on the invalid category; performing a similarity search between the embedding of the invalid category and reference embeddings to identify a similar reference embedding, wherein the reference embeddings correspond to valid categories; and determining the valid category based on the similar reference embedding.

In some implementations, performing the similarity search may include at least one of: a vector similarity search, k-nearest neighbour matching, approximate nearest neighbour search, cosine similarity or dot product method.

In some implementations, determining that the category is an invalid category includes: comparing the category to valid categories; and determining that the category does not match any of the valid categories.

In some implementations, determining that the category is an invalid category includes: computing an embedding based on the category; performing a similarity search between the embedding of the category and reference embeddings, wherein the reference embeddings correspond to valid categories; and determining that the embedding does not match any of the reference embeddings.

In some implementations, the computer-implemented method further includes further fine tuning the generative language model using at least one of: the valid category, the invalid category, a differential between the valid category and the invalid category, or the input to the generative language model.

In some implementations, the computer-implemented method further includes determining training data to fine tune the generative language model based on at least one of: the valid category, the invalid category, or the input to the generative language model.

In some implementations, the invalid category is expressed by the generative language model as a list having sub-categories hierarchically arranged relative to one another.

In some implementations, determining that the category is an invalid category includes determining that at least one of the sub-categories is an invalid sub-category.

In some implementations, substituting the invalid category with the valid category comprises substituting the at least one invalid sub-category with at least one valid sub-category.

In another aspect, there is provided a system. The system includes at least one processor. The system may further include a memory storing processor-executable instructions that, when executed by the at least one processor, cause the at least one processor to: provide a prompt to a generative language model, the prompt instructing the generative language model to generate output that classifies an input to the generative language model; receive the output from the generative language model, the output classifying the input into a category; determine that the category is an invalid category; obtain a valid category based on the invalid category; and substitute the invalid category with the valid category.

In some implementations, obtaining the valid category based on the invalid category may include: computing an embedding based on the invalid category; performing a similarity search between the embedding of the invalid category and reference embeddings to identify a similar reference embedding, wherein the reference embeddings correspond to valid categories; and determining the valid category based on the similar reference embedding.

In some implementations, performing the similarity search may include at least one of: a vector similarity search, k-nearest neighbour matching, approximate nearest neighbour search, cosine similarity or dot product method.

In some implementations, determining that the category is an invalid category further includes: comparing the category to valid categories; and determining that the category does not match any of the valid categories.

In some implementations, determining that the category is an invalid category further includes: computing an embedding based on the category; performing a similarity search between the embedding of the category and reference embeddings, wherein the reference embeddings correspond to valid categories; and determining that the embedding does not match any of the reference embeddings.

In some implementations, the at least one processor is to further fine tuning the generative language model using at least one of: the valid category, the invalid category, a differential between the valid category and the invalid category, or the input to the generative language model.

In some implementations, the invalid category is expressed by the generative language model as a list having sub-categories hierarchically arranged relative to one another.

In some implementations, determining that the category is an invalid category includes determining that at least one of the sub-categories is an invalid sub-category.

In some implementations, substituting the invalid category with the valid category comprises substituting the at least one invalid sub-category with at least one valid sub-category.

In another aspect, there is provided one or more computer readable media having stored thereon computer-executable instructions that, when executed by at least one processor, cause the at least one processor to perform any of the methods disclosed herein. The one or more computer readable media may be non-transitory.

### BRIEF DESCRIPTION OF THE DRAWINGS

Embodiments will be described, by way of example only, with reference to the accompanying figures wherein:

FIG. 1A is a simplified block diagram of an example simplified convolutional neural network;

FIG. 1B is a simplified block diagram of an example transformer neural network;

FIG. 2 is a block diagram of an example computing system;

FIG. 3 is a block diagram of an example system for correcting invalid output;

FIG. 4 is a block diagram of another example system for correcting invalid output, according to some embodiments;

FIG. 5 is a block diagram of an example communication system for a user device to communicate with the system of FIG. 3;

FIG. 6 illustrates an example multi-step processes for correcting an input using the system of FIG. 3;

FIG. 7 illustrates an additional example of the multi-step process of FIG. 6;

FIG. 8 illustrates an example of an output corrector process from the multi-step process of FIG. 7;

FIGS. 9A-9B illustrate an example of an output validity assessment subprocess and a valid output substitution subprocess in the output corrector process of FIG. 8;

FIGS. 10A-10B illustrate another example of an output validity assessment subprocess and a valid output substitution subprocess in the output corrector process of FIG. 8, according to some embodiments;

FIG. 11 illustrates a method performed by a computing system;

FIGS. 12-14 illustrate examples corresponding to steps of the method of FIG. 11; and

FIG. 15 illustrates another example of the multi-step process of FIG. 6, according to some embodiments.

### DETAILED DESCRIPTION

For illustrative purposes, specific embodiments will now be explained in greater detail below in conjunction with the figures.

To assist in understanding the present disclosure, some concepts relevant to neural networks and machine learning (ML) are first discussed.

Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which need not be discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), and multilayer perceptrons (MLPs), among others.

DNNs are often used as ML-based models for modeling complex behaviors (e.g., human language, image recognition, object classification, etc.) in order to improve accuracy of outputs (e.g., more accurate predictions) such as, for example, as compared with models with fewer layers. In the present disclosure, the term “ML-based model” or more simply “ML model” may be understood to refer to a DNN. Training a ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model. For example, to train a ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. In another example, to train a ML model that is intended to classify images, the training dataset may be a collection of images. Training data may be annotated with ground truth labels (e.g. each data entry in the training dataset may be paired with a label), or may be unlabeled.

Training a ML model generally involves inputting into an ML model (e.g. an untrained ML model) training data to be processed by the ML model, processing the training data using the ML model, collecting the output generated by the ML model (e.g. based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or may be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training a ML model. Backpropagation is used to adjust (also referred to as update) the value of the parameters in the ML model, with the goal of optimizing the objective function. For example, a defined loss function is calculated by forward propagation of an input to obtain an output of the ML model and comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively, so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of a ML model typically involves further training the ML model on a number of data samples (which may be smaller in number/cardinality than those used to train the model initially) that closely target the specific task. For example, a ML model for generating natural language that has been trained generically on publicly-available text corpuses may be, e.g., fine-tuned by further training using the complete works of Shakespeare as training data samples (e.g., where the intended use of the ML model is generating a scene of a play or other textual content in the style of Shakespeare).

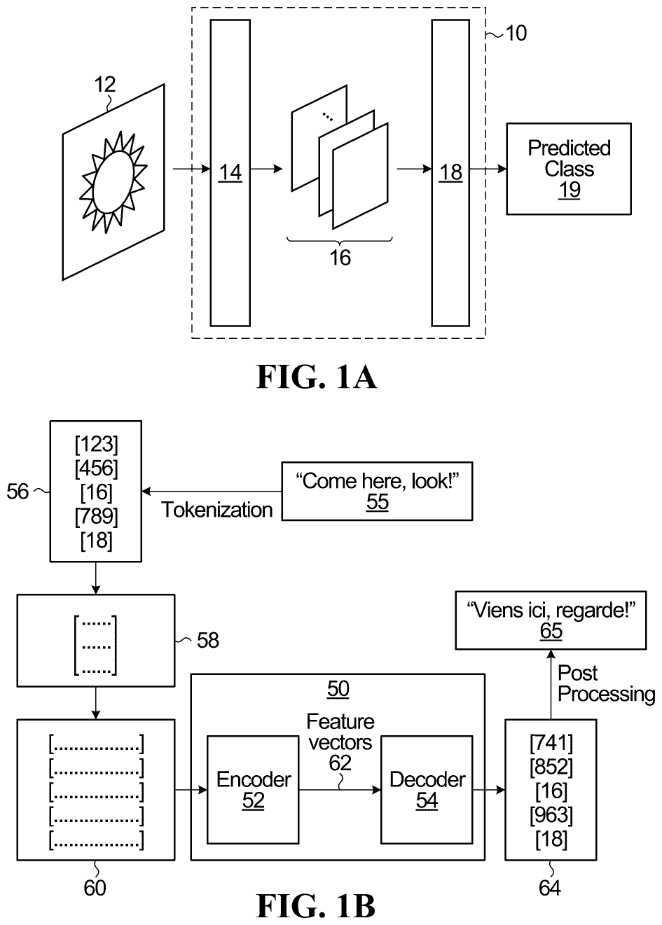

FIG. 1A is a simplified diagram of an example CNN 10, which is an example of a DNN that is commonly used for image processing tasks such as image classification, image analysis, object segmentation, etc. An input to the CNN 10 may be a 2D RGB image 12.

The CNN 10 includes a plurality of layers that process the image 12 in order to generate an output, such as a predicted classification or predicted label for the image 12. For simplicity, only a few layers of the CNN 10 are illustrated including at least one convolutional layer 14. The convolutional layer 14 performs convolution processing, which may involve computing a dot product between the input to the convolutional layer 14 and a convolution kernel. A convolutional kernel is typically a 2D matrix of learned parameters that is applied to the input in order to extract image features. Different convolutional kernels may be applied to extract different image information, such as shape information, color information, etc.

The output of the convolution layer 14 is a set of feature maps 16 (sometimes referred to as activation maps). Each feature map 16 generally has smaller width and height than the image 12. The set of feature maps 16 encode image features that may be processed by subsequent layers of the CNN 10, depending on the design and intended task for the CNN 10. In this example, a fully connected layer 18 processes the set of feature maps 16 in order to perform a classification of the image, based on the features encoded in the set of feature maps 16. The fully connected layer 18 contains learned parameters that, when applied to the set of feature maps 16, outputs a set of probabilities representing the likelihood that the image 12 belongs to each of a defined set of possible classes. The class having the highest probability may then be outputted as the predicted classification for the image 12.

In general, a CNN may have different numbers and different types of layers, such as multiple convolution layers, max-pooling layers and/or a fully connected layer, among others. The parameters of the CNN may be learned through training, using data having ground truth labels specific to the desired task (e.g., class labels if the CNN is being trained for a classification task, pixel masks if the CNN is being trained for a segmentation task, text annotations if the CNN is being trained for a captioning task, etc.), as discussed above.

Some concepts in ML-based language models are now discussed. It may be noted that, while the term “language model” has been commonly used to refer to a ML-based language model, there could exist non-ML language models. In the present disclosure, the term “language model” may be used as shorthand for ML-based language model (i.e., a language model that is implemented using a neural network or other ML architecture), unless stated otherwise. For example, unless stated otherwise, “language model” encompasses LLMs.

A language model may use a neural network (typically a DNN) to perform natural language processing (NLP) tasks such as language translation, image captioning, grammatical error correction, and language generation, among others. A language model may be trained to model how words relate to each other in a textual sequence, based on probabilities. A language model may contain hundreds of thousands of learned parameters or in the case of a large language model (LLM) may contain millions or billions of learned parameters or more.

In recent years, there has been interest in a type of neural network architecture, referred to as a transformer, for use as language models. For example, the Bidirectional Encoder Representations from Transformers (BERT) model, the Transformer-XL model and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

FIG. 1B is a simplified diagram of an example transformer 50, and a simplified discussion of its operation is now provided. The transformer 50 includes an encoder 52 (which may comprise one or more encoder layers/blocks connected in series) and a decoder 54 (which may comprise one or more decoder layers/blocks connected in series). Generally, the encoder 52 and the decoder 54 each include a plurality of neural network layers, at least one of which may be a self-attention layer. The parameters of the neural network layers may be referred to as the parameters of the language model.

The transformer 50 may be trained on a text corpus that is labelled (e.g., annotated to indicate verbs, nouns, etc.) or unlabelled. LLMs may be trained on a large unlabelled corpus. Some LLMs may be trained on a large multi-language, multi-domain corpus, to enable the model to be versatile at a variety of language-based tasks such as generative tasks (e.g., generating human-like natural language responses to natural language input).

An example of how the transformer 50 may process textual input data is now described. Input to a language model (whether transformer-based or otherwise) typically is in the form of natural language as may be parsed into tokens. It should be appreciated that the term “token” in the context of language models and NLP has a different meaning from the use of the same term in other contexts such as data security. Tokenization, in the context of language models and NLP, refers to the process of parsing textual input (e.g., a character, a word, a phrase, a sentence, a paragraph, etc.) into a sequence of shorter segments that are converted to numerical representations referred to as tokens (or “compute tokens”). Typically, a token may be an integer that corresponds to the index of a text segment (e.g., a word) in a vocabulary dataset. Often, the vocabulary dataset is arranged by frequency of use. Commonly occurring text, such as punctuation, may have a lower vocabulary index in the dataset and thus be represented by a token having a smaller integer value than less commonly occurring text. Tokens frequently correspond to words, with or without whitespace appended. In some examples, a token may correspond to a portion of a word. For example, the word “lower” may be represented by a token for [low] and a second token for [er]. In another example, the text sequence “Come here, look!” may be parsed into the segments [Come], [here], [,], [look] and [!], each of which may be represented by a respective numerical token. In addition to tokens that are parsed from the textual sequence (e.g., tokens that correspond to words and punctuation), there may also be special tokens to encode non-textual information. For example, a [CLASS] token may be a special token that corresponds to a classification of the textual sequence (e.g., may classify the textual sequence as a poem, a list, a paragraph, etc.), a [EOT] token may be another special token that indicates the end of the textual sequence, other tokens may provide formatting information, etc.

In FIG. 1B, a short sequence of tokens 56 corresponding to the text sequence “Come here, look!” is illustrated as input to the transformer 50. Tokenization of the text sequence into the tokens 56 may be performed by some pre-processing tokenization module such as, for example, a byte pair encoding tokenizer (the “pre” referring to the tokenization occurring prior to the processing of the tokenized input by the LLM), which is not shown in FIG. 1B for simplicity. In general, the token sequence that is inputted to the transformer 50 may be of any length up to a maximum length defined based on the dimensions of the transformer 50 (e.g., such a limit may be 2048 tokens in some LLMs). Each token 56 in the token sequence is converted into an embedding vector 60 (also referred to simply as an embedding). An embedding 60 is a learned numerical representation (such as, for example, a vector) of a token that captures some semantic meaning of the text segment represented by the token 56. The embedding 60 represents the text segment corresponding to the token 56 in a way such that embeddings corresponding to semantically-related text are closer to each other in a vector space than embeddings corresponding to semantically-unrelated text. For example, assuming that the words “look”, “see”, and “cake” each correspond to, respectively, a “look” token, a “see” token, and a “cake” token when tokenized, the embedding 60 corresponding to the “look” token will be closer to another embedding corresponding to the “see” token in the vector space, as compared to the distance between the embedding 60 corresponding to the “look” token and another embedding corresponding to the “cake” token. The vector space may be defined by the dimensions and values of the embedding vectors. Various techniques may be used to convert a token 56 to an embedding 60. For example, another trained ML model may be used to convert the token 56 into an embedding 60. In particular, another trained ML model may be used to convert the token 56 into an embedding 60 in a way that encodes additional information into the embedding 60 (e.g., a trained ML model may encode positional information about the position of the token 56 in the text sequence into the embedding 60). In some examples, the numerical value of the token 56 may be used to look up the corresponding embedding in an embedding matrix 58 (which may be learned during training of the transformer 50).

The generated embeddings 60 are input into the encoder 52. The encoder 52 serves to encode the embeddings 60 into feature vectors 62 that represent the latent features of the embeddings 60. The encoder 52 may encode positional information (i.e., information about the sequence of the input) in the feature vectors 62. The feature vectors 62 may have very high dimensionality (e.g., on the order of thousands or tens of thousands), with each element in a feature vector 62 corresponding to a respective feature. The numerical weight of each element in a feature vector 62 represents the importance of the corresponding feature. The space of all possible feature vectors 62 that can be generated by the encoder 52 may be referred to as the latent space or feature space.

Conceptually, the decoder 54 is designed to map the features represented by the feature vectors 62 into meaningful output, which may depend on the task that was assigned to the transformer 50. For example, if the transformer 50 is used for a translation task, the decoder 54 may map the feature vectors 62 into text output in a target language different from the language of the original tokens 56. Generally, in a generative language model, the decoder 54 serves to decode the feature vectors 62 into a sequence of tokens. The decoder 54 may generate output tokens 64 one by one. Each output token 64 may be fed back as input to the decoder 54 in order to generate the next output token 64. By feeding back the generated output and applying self-attention, the decoder 54 is able to generate a sequence of output tokens 64 that has sequential meaning (e.g., the resulting output text sequence is understandable as a sentence and obeys grammatical rules). The decoder 54 may generate output tokens 64 until a special [EOT] token (indicating the end of the text) is generated. The resulting sequence of output tokens 64 may then be converted to a text sequence in post-processing. For example, each output token 64 may be an integer number that corresponds to a vocabulary index. By looking up the text segment using the vocabulary index, the text segment corresponding to each output token 64 can be retrieved, the text segments can be concatenated together and the final output text sequence (in this example, “Viens ici, regarde!”) can be obtained.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that may be considered to be an encoder-only language model. A decoder-only language model accepts embeddings as input and may use auto-regression to generate an output text sequence. Transformer-XL and GPT-type models may be language models that are considered to be decoder-only language models.

Because GPT-type language models tend to have a large number of parameters, these language models may be considered LLMs. An example GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2048 input tokens), and is able to generate a large number of tokens as output (e.g., up to 2048 tokens). GPT-3 has been trained as a generative model, meaning that it can process input text sequences to predictively generate a meaningful output text sequence.

ChatGPT is built on top of a GPT-type LLM, and has been fine-tuned with training datasets based on text-based chats (e.g., chatbot conversations). ChatGPT is designed for processing natural language, receiving chat-like inputs and generating chat-like outputs.

A computing system may access a remote language model (e.g., a cloud-based language model), such as ChatGPT or GPT-3, via a software interface (e.g., an application programming interface (API)). Additionally or alternatively, such a remote language model may be accessed via a network such as, for example, the Internet. In some implementations such as, for example, potentially in the case of a cloud-based language model, a remote language model may be hosted by a computer system as may include a plurality of cooperating (e.g., cooperating via a network) computer systems such as may be in, for example, a distributed arrangement. Notably, a remote language model may employ a plurality of processors (e.g., hardware processors such as, for example, processors of cooperating computer systems). Indeed, processing of inputs by an LLM may be computationally expensive/may involve a large number of operations (e.g., many instructions may be executed/large data structures may be accessed from memory) and providing output in a required timeframe (e.g., real-time or near real-time) may require the use of a plurality of processors/cooperating computing devices as discussed above.

Inputs to an LLM may be referred to as a prompt, which is a natural language input that includes instructions to the LLM to generate a desired output. A computing system may generate a prompt that is provided as input to the LLM via its API. As described above, the prompt may optionally be processed or pre-processed into a token sequence prior to being provided as input to the LLM via its API. A prompt can include one or more examples of the desired output, which provides the LLM with additional information to enable the LLM to better generate output according to the desired output. Additionally or alternatively, the examples included in a prompt may provide inputs (e.g., example inputs) corresponding to/as may be expected to result in the desired outputs provided. A one-shot prompt refers to a prompt that includes one example, and a few-shot prompt refers to a prompt that includes multiple examples. A prompt that includes no examples may be referred to as a zero-shot prompt.

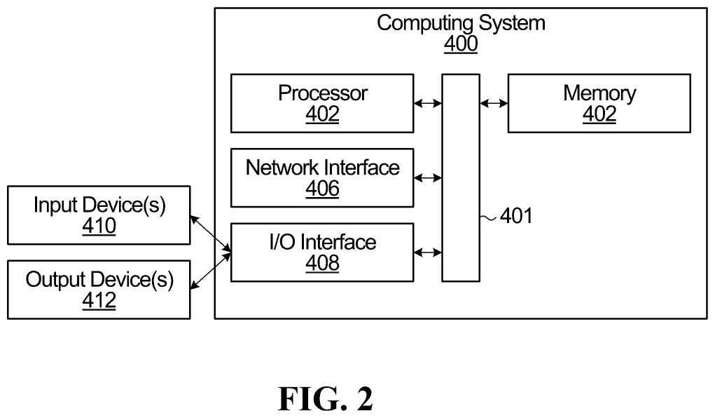

FIG. 2 illustrates an example computing system 400, which may be used to implement examples of the present disclosure, such as a prompt generation engine to generate prompts to be provided as input to a language model such as a LLM. Additionally or alternatively, one or more instances of the example computing system 400 may be employed to execute the LLM. For example, a plurality of instances of the example computing system 400 may cooperate to provide output using an LLM in manners as discussed above.

The example computing system 400 includes at least one processing unit, such as a processor 402, and at least one physical memory 404. The processor 402 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. The memory 404 may include a volatile or non-volatile memory (e.g., a flash memory, a random access memory (RAM), and/or a read-only memory (ROM)). The memory 404 may store instructions for execution by the processor 402, to the computing system 400 to carry out examples of the methods, functionalities, systems and modules disclosed herein.

The computing system 400 may also include at least one network interface 406 for wired and/or wireless communications with an external system and/or network (e.g., an intranet, the Internet, a P2P network, a WAN and/or a LAN). A network interface may enable the computing system 400 to carry out communications (e.g., wireless communications) with systems external to the computing system 400, such as a language model residing on a remote system.

The computing system 400 may optionally include at least one input/output (I/O) interface 408, which may interface with optional input device(s) 410 and/or optional output device(s) 412. Input device(s) 410 may include, for example, buttons, a microphone, a touchscreen, a keyboard, etc. Output device(s) 412 may include, for example, a display, a speaker, etc. In this example, optional input device(s) 410 and optional output device(s) 412 are shown external to the computing system 400. In other examples, one or more of the input device(s) 410 and/or output device(s) 412 may be an internal component of the computing system 400.

A computing system, such as the computing system 400 of FIG. 2, may access a remote system (e.g., a cloud-based system) to communicate with a remote language model or LLM hosted on the remote system such as, for example, using an application programming interface (API) call. The API call may include an API key to enable the computing system to be identified by the remote system. The API call may also include an identification of the language model or LLM to be accessed and/or parameters for adjusting outputs generated by the language model or LLM, such as, for example, one or more of a temperature parameter (which may control the amount of randomness or “creativity” of the generated output) (and/or, more generally some form of random seed as serves to introduce variability or variety into the output of the LLM), a minimum length of the output (e.g., a minimum of 10 tokens) and/or a maximum length of the output (e.g., a maximum of 1000 tokens), a frequency penalty parameter (e.g., a parameter which may lower the likelihood of subsequently outputting a word based on the number of times that word has already been output), a “best of” parameter (e.g., a parameter to control the number of times the model will use to generate output after being instructed to, e.g., produce several outputs based on slightly varied inputs). The prompt generated by the computing system is provided to the language model or LLM and the output (e.g., token sequence) generated by the language model or LLM is communicated back to the computing system. In other examples, the prompt may be provided directly to the language model or LLM without requiring an API call. For example, the prompt could be sent to a remote LLM via a network such as, for example, as or in message (e.g., in a payload of a message).

### Correcting Hallucination in Output From a Generative Language Model

The LLM discussed above is an example of a generative language model. In some examples, LLMs (and in general generative language models) may tend to “hallucinate,” such that they provide an output that is incorrect or not relevant to the input to the LLM.

To help avoid this hallucination, the textual input may instead ask the LLM to categorize the input into a taxonomy (e.g. “cars” or “electronics”), thus increasing the specificity of the textual input. The categories may also be specified within the input (e.g. “luxury cars”, “sedans” and “trucks”). However, although the output category generated by the LLM may be correct or almost correct, it may not fit within a desired terminology. For example, although the output category may correctly identify an input image as depicting a “Luxury Car,” the desired terminology for this category may instead be “Luxury Automobile.” The generation of “Luxury Car” instead of “Luxury Automobile” by the LLM is a form of hallucination. Hallucination is a technical problem of the LLM, e.g. that may arise due to factors such as overfitting or underfitting, e.g. stemming from incomplete or not enough training or fine-tuning of the LLM.

In another example, a generative language model, such as an LLM, may be prompted with an input to classify into a category. The input may be text, an image or some combination of input types. The output category may, for example, be as follows: “Electronics>Electronic Accessories>Computer Components>Input Devices>Game Controllers>Game System Controller”. However, this output category may be invalid because the LLM has hallucinated. In particular, the node or substring “Game System Controller” in the LLM's output may be invalid. Rather, the correct node or substring would be “System Controllers”.

One method of addressing this problem may be to enforce a grammar at the LLM's output as it generates each token. However, implementing these grammars may be computationally expensive. For example, in situations where the category is hierarchical, the raw grammar file may first need to be formulated as a finite state machine having many states and transitions corresponding to all permutations of allowable output before the LLM can begin using the grammar, consuming significant computational resources. As well, although enforcing the grammar requires computational resources and adds latency, in some cases it may provide only limited benefit because the LLM may also generate a valid category in the absence of grammar enforcement. Even though grammar enforcement may provide a significant benefit if the LLM hallucinates, it is not known in advance whether or not the LLM will hallucinate, and so the grammar enforcement is always applied.

In addition, even if the computational expense is affordable, hierarchical outputs and categories may pose an additional challenge, such as in the example hierarchical category “Electronics>Electronic Accessories>Computer Components>Input Devices>Game Controllers>Game System Controller”. In particular, once the grammar constrains the output to begin traversing a certain hierarchical path, e.g. “Electronics>Computer Hardware,” the LLM will be limited to that path only. That is, the grammar-constrained LLM is not able to go back and revise previous tokens, such as replacing “Computer Hardware” with “Electronic Accessories” to attempt a different hierarchical path. Thus, although hallucination by the LLM may be limited by constraining its output with a grammar, there is no way for the grammar or the LLM itself to ensure that the LLM still generates the correct category as output once it has made a hierarchical misstep, even if that misstep is to a valid category or sub-category.

In addition to the problems discussed above, grammar enforcement is not supported by some LLMs.

One possible solution to these problems is to use a semantic replacement method after the LLM finishes outputting the category.

As a first step, the semantic replacement method determines whether the category output by the LLM is invalid. This may involve comparing the output category to a plurality of valid categories, such as valid categories stored in a database. If the output category matches (or is sufficiently similar to, in some examples) a valid category, the method does not need to proceed because the output category is already valid.

However, if the output category does not match (or sufficiently match) a valid category, the output is an invalid category and the method may proceed to the second step. The second step includes obtaining a valid category that is similar to or related (e.g. most related) to the invalid category output by the LLM.

Once the valid category has been obtained, the method may proceed to the third step. The third step includes replacing the invalid category output by the LLM with the valid category.

In some examples, the method may determine whether the output category matches a valid category by embedding the output category, i.e. generating an embedding vector corresponding to the output category. The embedding corresponding to the output category may then be compared to reference embeddings corresponding to the valid categories. The reference embeddings and/or valid categories may be stored in a database. If the embedding corresponding to the output category matches one of the reference embeddings (or is sufficiently similar to one of the reference embeddings), then the method may determine that the output category is valid. However, if no match is found, the method may instead determine that the output category is invalid. In other examples, embedding is not used to determine whether the output category is valid, e.g. the text of the output category may be directly compared to text of valid categories to determine if there is a match.

The embeddings may also be used to obtain a valid category that is most related to the invalid category output by the LLM. After comparing the reference embeddings to the embedding corresponding to the invalid category, the most related reference embedding may be determined and its corresponding valid category may be selected. This comparison may be performed using at least one of: a vector search, k-nearest neighbour matching, approximate nearest neighbour search, cosine similarity, dot product and/or fuzzy search method.

In some examples, this method may be used to improve the accuracy of the LLM, which may include re-training the LLM. Re-training the LLM may be or include fine-tuning (e.g. further fine-tuning) the LLM.

One example is as follows. A prompt may be provided to a generative language model. The prompt may instruct the generative language model to generate output that classifies an input to the generative language model. The input may be text, an image, any other data format, or some combination of multiple data formats. In the example, the input may be a picture of a sports car. Output may be received from the generative language model. The output may classify the input into a category. In the example, the output may be “Automobiles>Luxury Cars>Sports Cars.” It may be determined that the category is an invalid category. In the example, “Luxury Cars” may not be a valid subcategory of the category, thereby resulting in an invalid category. A valid category may be obtained based on the invalid category. In the example, the valid category may be “Automobiles>Luxury Automobiles>Sports Cars,” which is known to be valid but may be obtained because it is similar to the invalid category. The invalid category may substituted with the valid category.

The term “similar to” as used herein may mean identical to, related to (either semantically, literally, visually, algorithmically or mathematically, whether before or after some intermediate processing steps), associated with (e.g. associated in memory or in a database), derivative from (e.g. a first element may be similar to a second element if the first element can be derived from the second element), etc. For example, if two elements are each encoded in a respective n-dimensional vector, “similar to” could refer to the relative distance between these two vectors in the n-dimensional space being less than a particular threshold. In another example, “similar to” could refer to the two vectors neighbouring each other and/or being closest to each other in the n-dimensional space. In one example, a reference embedding (representing a valid category) is “similar to” an invalid category embedding if the reference embedding is neighbouring (e.g. a neighbour to) the invalid category embedding in the embedding space, e.g. as identified in a nearest-neighbour or approximate nearest neighbour search. In another example, if a first element may be modified relatively little to become a second element, those two elements may also be considered as similar to one another. Other definitions of this term may also be possible.

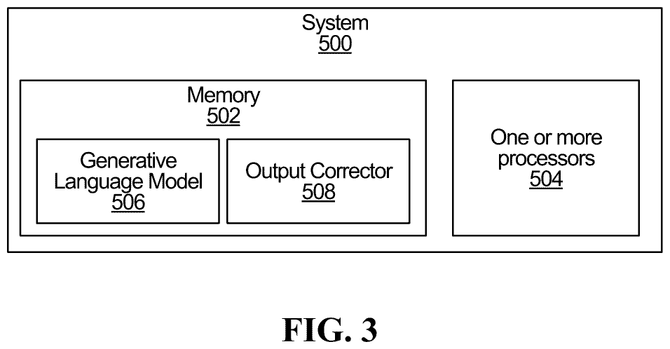

FIG. 3 illustrates an example of a system 500. System 500 may be used to correct an output generated by a generative language model.

For example, generative language model may classify an output into a category. System 500 may determine whether the category is invalid and, if the category is invalid, correct the category. It will be appreciated that the term “category”, as used herein, may include a “classification”, a “description”, a “response”, “descriptive language” or any other form of output generated by the generative language model in which the generative language model is performing a classification related to an input to the generative language model. In some implementations, a category may also be understood to include a node in a tree data structure, such as a child node to a parent/root node, a child node of another child node (i.e. in a hierarchical category), or a parent/root node.

System 500 includes a memory 502 and one or more processors 504. Memory 502 stores a generative language model 506 and an output corrector 508. By “storing” generative language model 506, it is meant that the parameters and other values that make up generative language model 506 and that are required for execution of generative language model 506 are stored. The parameters depend upon how generative language model 506 is implemented. For example, assuming generative language model 506 utilizes one or more neural networks, the weights and biases of the one or more neural networks are stored.

Generative language model 506 may have been trained on a generic data set, such as a large corpus of text, images or other data. Generative language model 506 may be an LLM. The LLM may have the example LLM structure described earlier in relation to FIG. 1B, or it may have another structure, e.g. it may only implement a decoder or an encoder, rather than both. The exact structure of the LLM is implementation specific.

In addition, by storing output corrector 508, it is meant that the computer-implemented instructions which make up output corrector 508 and are required for execution of output corrector 508 are stored. Output corrector 508 may be used by system 500 to correct output generated by generative language model 506. For example, output corrector 508 may determine that an output category generated by generative language model 506 is invalid because generative language model 506 hallucinated. Output corrector 508 may replace the invalid output category with a valid output category. The valid output category may be similar to the invalid output category generative by generative language model 506.

In some examples, output corrector 508 may also include one or more files, databases and/or other data structures, in addition to computer-implemented instructions. The files, databases and/or other data structures may include valid categories.

One or more processors 504 may execute generative language model 506 and output corrector 508.

One or more processors 504 may each be implemented as a processor that executes instructions stored in memory, or it/they may be or include dedicated integrated circuits, such as one or more field programmable gate arrays (FPGAs) and/or one or more application-specific integrated circuits (ASICs). One or more processors 504 may be or include one or more processing cores. One or more processors 504 may be or include one or more processing cores on a GPU.

In some examples, one or more processors 504 may execute the instructions for output correct 508 stored in memory 502 to correct the output of generative language model 506.

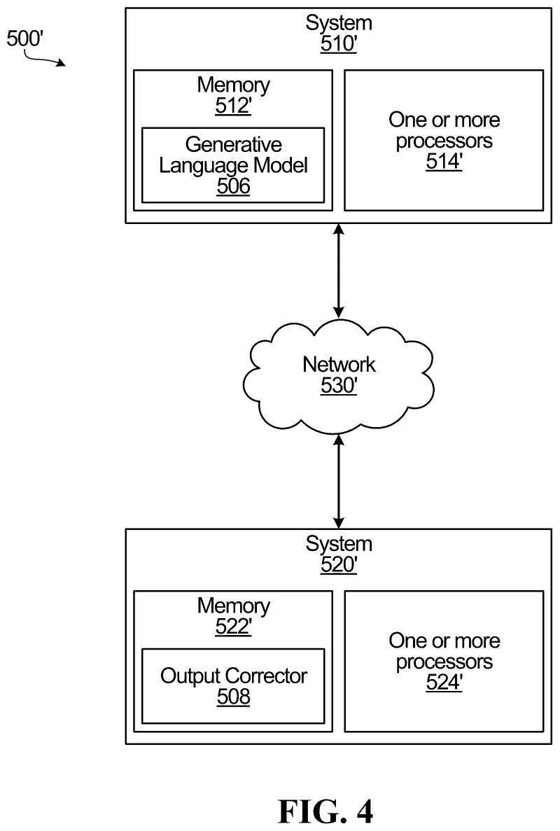

FIG. 4 depicts an alternative example of a system 500′.

System 500′ includes a system 510′, which includes a memory 512′ and one or more processors 514′. Memory 512′ includes generative language model 506. One or more processors 514′ may execute generative language model 506.

In addition, system 500′ also includes system 520′, which includes a memory 522′ and one or more processors 524′. Memory 522′ includes output corrector 508. One or more processors 524′ may execute output corrector 508.

System 500′ also includes a network 530′. System 510′ and system 520′ may communicate with one another over network 530′ For example, generative language model may transmit its output through network 530′ to system 520′ for validity assessment and/or correction by output corrector 508. System 520′ may also transmit output validity assessment and/or corrected output (e.g. a valid output category similar to the output generated by generative language model 506) through network 530′ to system 510′ and generative language model 506. In other examples, system 520′ may also transmit output validity assessment and/or corrected output to one or more other systems, not depicted.

System 500′ may be otherwise identical to system 500.

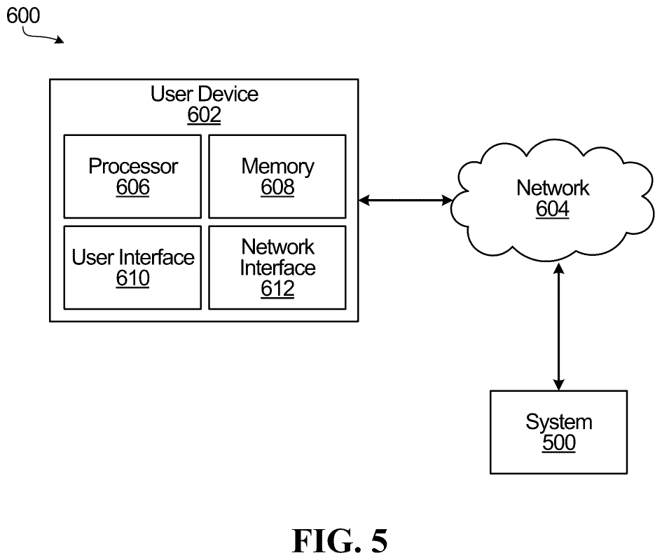

FIG. 5 depicts a computing system 600, which allows a user device 602 to communicate with system 500 over a network 604. In other implementations, system 500 may instead be system 500′ depicted in FIG. 4. It will be appreciated that in further implementations, system 600 may allow user device 602 to communicate with more than one system, such as a combination of system 500 and system 500′, and/or multiple instances of either of these systems.

User device 602 includes at least one processor 606 and at least one physical memory 608. Processor 606 may be, for example, a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof. Memory 608 may include a volatile or non-volatile memory (e.g., a flash memory, a random access memory (RAM), and/or a read-only memory (ROM)). The memory 608 may store instructions for execution by the processor 606.

User device 602 may include at least one input/output (I/O) interface 610, alternatively referred to as user interface 610, which may interface with optional input device(s) (not shown) and/or optional output device(s) (not shown). Input device(s) may include, for example, buttons, a microphone, a touchscreen, a keyboard, etc. Output device(s) may include, for example, a display, a speaker, etc. In this example, optional input device(s) and optional output device(s) may be external to user device 602. In other examples, one or more of the input device(s) and/or output device(s) may be an internal component of user device 602.

User device 602 may also include at least one network interface 612 for wired and/or wireless communications with an external system and/or network (e.g., an intranet, the Internet, a P2P network, a WAN and/or a LAN). A network interface may enable user device 602 to carry out communications (e.g., wireless communications) with systems external to user device 602, such as system 500 and/or system 500′ over a network 604. The structure of the network interface 612 will depend on how the user device 602 interfaces with network 604. For example, if user device 602 is a smartphone or tablet, network interface 612 may comprise a transmitter/receiver with an antenna to send and receive wireless transmissions over network 604. If the user device 602 is a personal computer connected to network 604 with a network cable, network interface 612 may comprise a network interface card (NIC), and/or a computer port (e.g. a physical outlet to which a plug or cable connects), and/or a network socket, etc.

It will be appreciated that computing system 600 may be used by a user of user device 602 to perform any method as described herein. Computing system 600 may also be used by a user of user device 602 to perform variations of these methods or other methods using system 500 and/or system 500′.

For example, user device 602 may transmit input, including an input prompt and/or input data, such as an image, video or some other data format, to system 500 (or system 500′ and/or system 900).

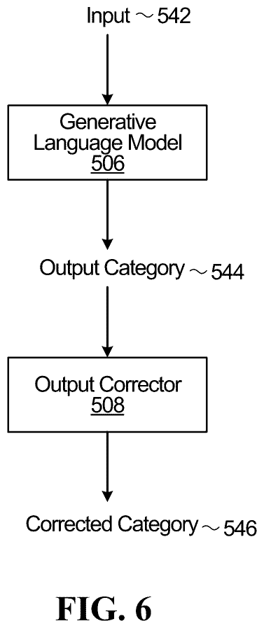

FIG. 6 depicts an example of applying system 500 to correct an output category generated by generative language model 506.

System 500 is “prompted” with input 542, which may include text, an image or both. It will be appreciated that input 542 may include multiple types of data, such as an image and text. For example, input 542 may include an image and prompt text. The prompt text may ask system 500 to classify or categorize input 542. In some implementations, the prompt text may ask system 500 to classify what is depicted in the image. The prompt text may also identify a taxonomy or set of categories for what is depicted within the image. In other examples, the prompt text may not explicitly identify any possible categories for what is depicted within the image.

In further implementations, input 542 may also or instead include other forms of data, such as videos, databases, computer objects and other formats of data.

It will be appreciated that system 500, including generative language model 506, may be multi-modal.

Input 542 is received by generative language model 506. As noted above, generative language model 506 may be an LLM. Generative language model 506 may generate an output category 544 into which input 542 has been classified or categorized. Generative language model 506 may also or instead generate an output which describes or is responsive to input 542. It will be understood that output category 544 may include a classification, a description or some other output from generative language model responsive to input 542.

Output category 544 generated by generative language model 506 is received by output corrector 508. Output corrector 508 may determine whether output category 544 is valid. For example, output corrector 508 may compare output category 544 to a list of valid categories to determine whether output category 544 is valid.

Valid categories may be retrieved from local memory, such as memory 502 or some other local memory within system 500, such as a local database within system 500.

Alternatively, valid categories may be retrieved from over a network, such as from another memory or database. An Application Programming Interface (API) or some other means may be used to retrieve valid categories from over a network. Valid categories may be in the form of a database, a text file, a common-separated value file or some other format, depending on the specific application.

In some alternative implementations, valid categories may be dynamically generated, such as after retrieving a portion or all of valid categories from a memory or database. In addition, valid categories may be processed by output corrector 508 or some other component of system 500, such as to sort, label or generate additional data for the valid categories.

Output category 544 may be compared to valid categories, such as by looping through each one of valid categories and comparing output category 544 to determine if there is a match or, in some examples, a near match. Alternatively, valid categories may be selected at random and compared to output category 544 to determine if there is a match. It will be appreciated that other methods may also be possible, such as a binary search and/or some pre-processing of output category 544 and/or valid categories. In some examples, valid categories may be sorted based on similarity or some other criteria.

If output corrector 508 determines that output category 544 is valid, such as after determining there is a match between output category 544 and a valid category, output corrector 508 may simply output category 544 without any correction (not depicted). System 500 may then continue to use output category 544, which output corrector 508 determined to be valid.

However, if output corrector 508 determines that output category 544 is invalid, such as after determining there is no match between output category 544 and a valid category, output correct 508 may correct output category 544. Correcting output category 544 may include substituting output category 544 with a valid category to generate a corrected category 546. The valid output category may be selected based on its similarity with the invalid output category 544.

In other examples, only a portion of output category 544 may be replaced with a valid category to generate corrected category 546.

In further examples, output category 544 may be corrected using other means in addition to those described above.

In the case where output category 544 was determined to be invalid, output corrector 508 outputs corrected category 546. Corrected category 546 may be used by system 500 instead of output category 544, which was determined by output corrector 508 to be invalid.

In some further implementations, output corrector 508 may determine that output category 544 is invalid without considering valid categories. For example, output category 544 may include information which may allow its validity to be tested without valid categories. In one particular example, output category 544 may include a checksum, which may be tabulated to determine whether output category 544 is valid.

It will be understood that the discussion herein of system 500 may equally apply to system 500′, such that all applications of system 500 may also apply to system 500′.

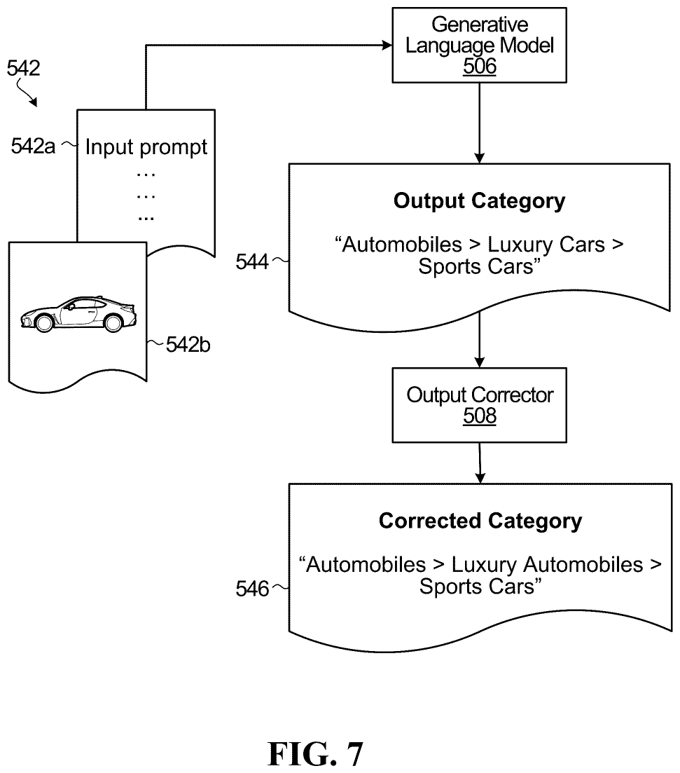

FIG. 7 depicts a further example of applying system 500. In the depicted example, input 542 includes an input prompt 542a and an image 542b. Input prompt 542a may be text, another type of data or a combination of multiple types of data. Image 542b may depict an automobile, such as a sports car.

Input prompt 542a may include text asking system 500 to generate output using image 542b.

For example, input prompt 512a may include text asking system 500 to classify what is depicted within image 542b. In some particular examples, the input prompt 542a may ask system 500 to categorize image 542b or categorize some aspect of what is depicted within image 542b. Input prompt 542a may also identify that image 542b depicts an “automobile” and may identify a plurality of categories within that taxonomy, e.g. “luxury”, “sedans” and “trucks” within which image 542b may be categorized. In other examples, input prompt 542a may not explicitly identify any possible categories for what is depicted within image 542b. In some further examples, input prompt 542a may also not identify a specific taxonomy, not even by name.

In the depicted example, input prompt 542a may instruct system 500 to categorize image 542b, which depicts a sports car.

In other examples, input prompt 542a may include text asking system 500 to describe what is depicted within image 542b, such as to describe certain attributes of image 542b or what image 542b depicts.

In further examples, input prompt 542a may include text asking system 500 to generate some other type of output, such as another image or data type, based in part on input image 542b, in which case generative language model 506 might more generally be a generative model that can generate other output besides language.

It will be appreciated that in other examples, input 542 may include other data types in addition to or instead of image 542b.

Input 542 is received by generative language model 506. In some implementations, input 542 may be transmitted over a network, such as using an API or some other means.

Generative language model 506 generates output category 544 based on input 542. As noted above, in the depicted example, input prompt 542a may instruct generative language model 56 to categorize image 542b, which depicts a sports car.

Output category 544 generated by generative language model 506 may include the category “Automobiles>Luxury Cars>Sports Cars”. Although output category 544 may be hierarchical in the depicted example, it will be understood that output category 544 does not need to be hierarchical. Alternatively, output category 544 may also include one or more sub-categories.

In the depicted example, the terminology or sub-category “Luxury Cars” may not be valid. That is, system 500 or later systems may not use this terminology. Other reasons for this terminology being invalid may be possible. Instead, the terminology or sub-category “Luxury Automobiles” may be preferred. As such, output category 544 may be invalid.

This invalid terminology or category “Luxury Cars” may be a result of generative language model 506 hallucinating while generating output category 544.

In some other examples, all of output category 544 may conform with preferred terminology or categories, such that output category 544 is valid. However, it will be understood that it may not be immediately ascertainable whether output category 544 is valid or not.

Output corrector 508 may be used to determine whether output category 544 has hallucinated. As well, as already described above, output corrector 508 may also be used to correct output category 544 if it is invalid.

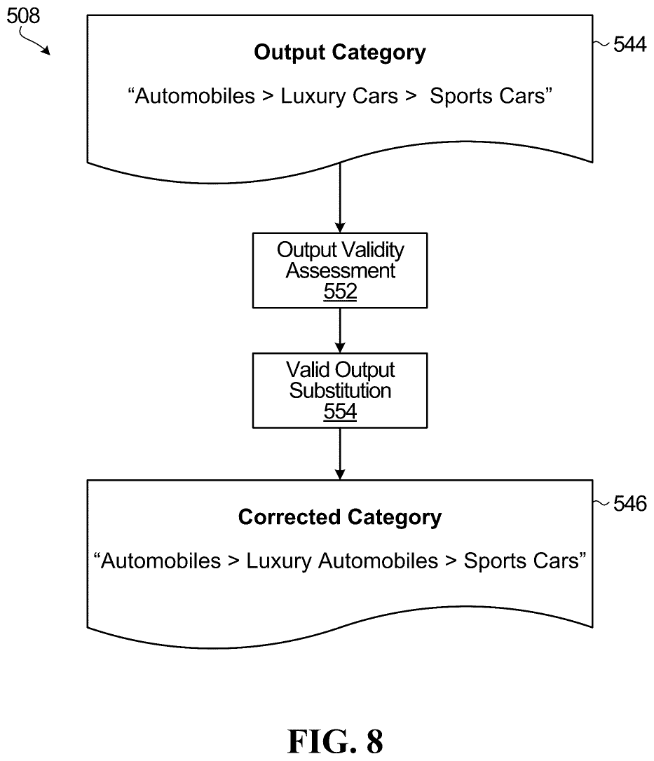

FIG. 8 depicts an example implementation of output corrector 508. Output corrector 508 may include performing output validity assessment 552 and valid output substitution 554.

Output corrector 508 may receive output category 544. As will be described in further detail below, output corrector 508 may first determine whether output category 544 is valid by performing output validity assessment 552. In some implementations, performing output validity assessment 552 may include obtaining a list of valid categories to determine whether output category 544 is valid. Performing output validity assessment 552 may also include comparing output category 544 to valid categories to determine whether there is a match. If there is a match between output category 544 and valid categories, output corrector 508 may determine that output category 544 is valid. If there is no match, output corrector 508 may determine that output category 544 is invalid.

In some other implementations, performing output validity assessment 552 may include assessing output category 544 without valid categories to determine whether output category 544 is valid. For example, output corrector 508 may calculate a checksum based on output category 544. If the checksum is within a certain range or equal to a certain value, output corrector 508 may determine that output category 544 is valid (or invalid).

If output corrector 508 determines that output category 544 is valid, output corrector 508 may bypass performing valid output substitution 554 and return output category 544. Output corrector 508 may also output an indication of whether output category 544 is valid or invalid.

However, if output corrector 508 determines that output category 544 is invalid, output corrector 508 may perform valid output substitution 554 using output category 544 to generate corrector category 544. Output corrector 508 may compare output category 544 to valid categories to determine which valid category should be used to substitute output category 554.

In the depicted example, performing valid output substitution 554 may include comparing output category 544, which includes the category “Automobiles>Luxury Cars>Sports Cars”, to valid categories. While performing valid output substitution 554, output correct 508 may have already determined that there is no valid category which matches this output category 544. As discussed above, this may be because no valid category contains the terminology “Luxury Cars”.

In some implementations, valid categories may have already been obtained while performing output validity assessment 552. In other implementations valid categories may need to be obtained while performing valid output substitution 554. Valid categories may be obtained as already described herein.

Once it is determined that output category 544 is invalid, output corrector 508 may determine which valid category should be used to substitute output category 554. Output corrector 508 may do this by determining which valid category is similar to or most similar to output category 554. Although output category 544 may have been determined to be invalid while performing output validity assessment 552, output corrector 508 may determine which of valid categories is/are still similar enough to output category 544 that generative language model 506 could have or should have generated that valid category or those valid categories as output.

The valid category most similar to output category 544 may be selected to be used to substitute output category 544.

In other examples, a valid category which is similar to but not most similar to output category 544 may be selected instead. In these examples, other aspects of valid category and output category 544 may also be considered to select the valid category with which to substitute output category 544.

In the depicted example, output corrector 508 may determine that the valid category “Automobiles>Luxury Automobiles>Sports Cars” is similar to or most similar to output category 544, which includes “Automobiles>Luxury Cars>Sports Cars”. This valid category may be selected by output corrector 508 for substitution while performing valid output substitution 554.

In some implementations, output corrector 508 may also pre-process, transform or perform calculations on output category 544 before comparing output category 544 to valid categories, as described in further detail below. In some implementations, output corrector 508 may additionally or instead pre-process, transform or perform calculations on valid categories.

Once output corrector 508 has determined which valid category should be used to substitute output category 544, output corrector 508 outputs that corrected category 544 containing the selected valid category instead of output category 544. In some examples, only a portion of the output from generative language model 506 may be substituted with the selected valid category, while in other examples all of the output from generative language model 506 may be substituted with the selected valid category.

In the depicted example where output category 508 was invalid, output category 508 output corrected category 544. Output category 544 may include the selected valid category “Automobiles>Luxury Automobiles>Sports Cars”.

As noted above, in addition to corrected category 544, output corrector 508 may additionally output an indication of whether output category is valid or invalid.

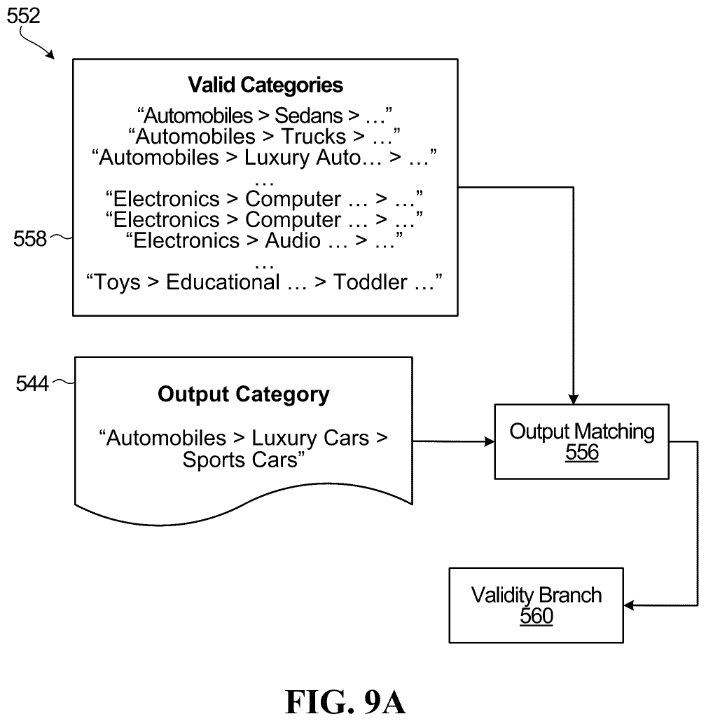

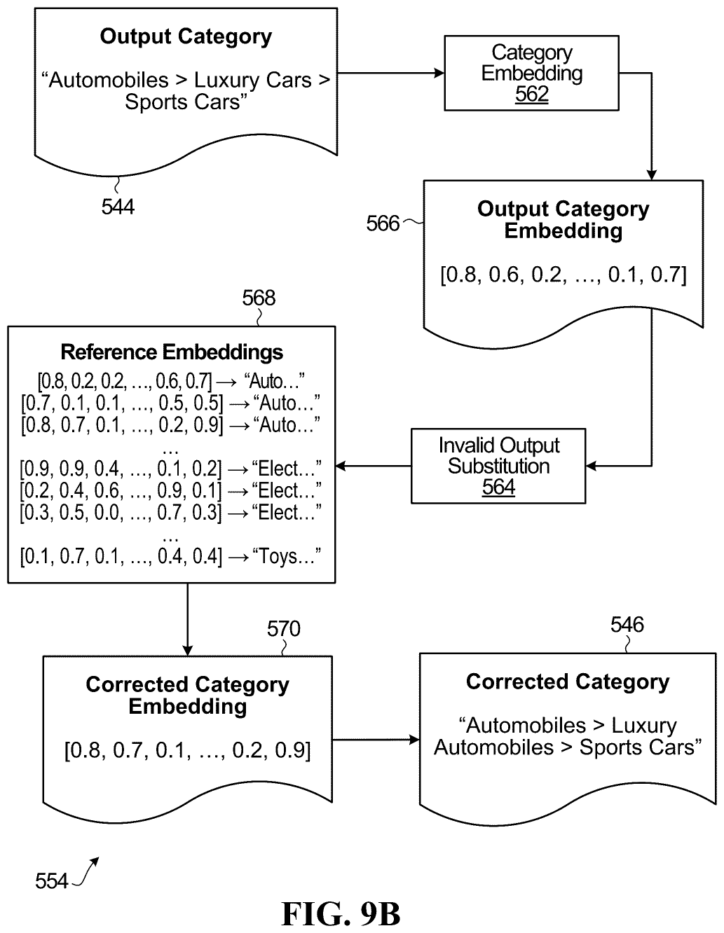

FIG. 9A depicts an example implementation of output validity assessment 552. While performing output validity assessment 552, output corrector 508 may perform output matching 556 and validity branch 560.

While performing output matching 556, output corrector 508 may assess whether output category 544 matches any valid categories, such as valid categories 558.

As noted above, valid categories 558 may be obtained from local memory or a local database, retrieved over a network or using some other means.

In the depicted example, valid categories 558 includes a list of valid categories, such as “Automobiles>Sedans> . . . ”, “Automobiles>Trucks> . . . ” and “Automobiles>Luxury Automobiles> . . . ”. It will be understood that other valid categories may also be listed, and that valid categories may be longer or shorter than those depicted in valid categories 558. As well, valid categories 558 may be hierarchical, as depicted, or may instead be non-hierarchical, e.g. “Sedans”, “Trucks”, etc.

Valid categories 558 may also be arranged alphabetically or sorted using some other metric or criteria.

Valid categories 558 may be stored in a file, a database or some other data object or data structure.

It will be appreciated that valid categories 558 may be in a format similar to that depicted in FIG. 9A or in a different format.

Valid categories 558 may also be associated with one or more other files.

Output corrector 508 may compare output category 544 generated by generative language model 506 to each of valid categories 558 until a match is found. In the depicted example, no match is found between output category 544 and any of valid categories 558.

In some other implementations, only a partial match may need to be found for output corrector to determine that a match has been found. For example, output category 544 may match a sub-string of valid categories 558, which may be sufficient to determine that there is a match.

If a match is found while performing output matching 556, output corrector 508 may determine that output category 544 is valid. If a match is not found, output corrector 508 may instead determine that output category 544 is invalid. This may have been caused, for example, by generative language model 506 hallucinating while generating output category 544.

After performing output matching 556, output correct 508 performs validity branch 560 to proceed depending on whether output category 544 was determined to be valid or invalid.

If output category 544 is determined to be valid while performing output matching 556, output corrector 508 may proceed directly from validity branch 560 to output, bypassing valid output substitution 554 altogether (see FIG. 8). As already discussed, valid output substitution 554 may normally follow output validity assessment 552. However, in this example, output corrector 508 may return output category 544 without any substitution. Output corrector 508 may also output an indication that output category 544 is valid.

However, if output category is determined to be invalid while performing output matching 556, output corrector 508 may proceed to valid output substitution 554. In some implementations, at this time output corrector 508 may output an indication that output category 544 is invalid. In other implementations, output corrector 508 may only output this indication once it has corrected output category 544.

FIG. 9B depicts an example implementation of valid output substitution 554.

Output corrector 508 may perform valid output substitution 554 after output validity assessment 552 if output corrector 508 determines that output category 544 is invalid. In some other implementations, output corrector 508 may still perform valid output substitution 554 even if output category 544 is determined to be valid by output corrector 508.

While performing valid output substitution 554, output corrector 508 may perform category embedding 562 and invalid output substitution 564.

Output corrector 508 may embed output category 508 while performing category embedding 562 to generate an output category embedding 566. Output category embedding 566 may be an embedding based on output category 544. An embedding is a learned numerical representation (such as, for example, a vector) of an input that captures some semantic meaning of the input (e.g. text) represented. The embedding represents the input (e.g. text) in a way such that embeddings corresponding to semantically-related input (e.g. text) are closer to each other in a vector space than embeddings corresponding to semantically-unrelated input (e.g. text). For example, an embedding may be a vector representation of a text input, such as output category 544. The embedding may be calculated by performing a text-to-vector translation of the output category 544. In the case of an n-dimensional vector, categories with semantic similarities may have embeddings which are grouped close together in the n-dimensional space.

An embedding may allow output corrector 508 to compare the semantic meaning of two more categories to one another, such as output category 544 and, for example, one or more valid categories.

It will be appreciated that there are many ways to embed an input, such as output category 544. In other implementations, other text-to-vector or text-to-number methods may be used to mathematically associate semantic meaning to output category 544.

In addition, in implementations where output category 544 is not text, embedding may still be used. For example, if output category 544 is an image, that image may also be embedded, converting the pixel values into an embedding vector which may be compared to other embeddings.

In the depicted example, output category embedding 566 for output category 544 may be the vector “[0.8, 0.6, 0.2, . . . , 0.1, 0.7]”. It will be understood that other values may also be possible.

While performing invalid output substitution 564, output corrector 564 may determine a valid output category with which to substitute or replace output category 544. Output corrector 564 performs invalid output substitution 564 based on output category embedding 566.

Output corrector 508 may also perform invalid output substitution 564 based on a list of reference embeddings, such as reference embeddings 568. Reference embeddings 568 may correspond to valid categories 558. For example, each of reference embeddings 568 may correspond to one of valid categories 558.

Reference embeddings 568 may be obtained by output corrector 508 from a local memory or database or from over a network. In some implementations, reference embeddings 568 may be obtained with valid categories 558. For example, valid categories 558 and their corresponding reference embeddings 568 may be contained within the same file or database.

In other implementations, output corrector 508 may process valid categories 558 to determine embeddings for each of the valid categories and thereby generate reference embeddings 568.

It will be appreciated that reference embeddings 568 and output category embedding 566 may be generated using the same or a similar method, such that the embeddings may be compared with one another to determine semantic similarity between reference embeddings 568 and output category embedding 566.

Output corrector 508 may perform a similarity search to determine which of reference embeddings 568 is similar to and/or most similar to output category embedding 566. For example, output corrector 508 may perform similarity searching including at least one of a vector similarity search, k-nearest neighbour matching, approximate nearest neighbour search, cosine similarity or dot product method. One or more similarity search methods may be used and search results assessed by output corrector 508 while performing invalid output substitution 564. Other similarity search methods may also be used in addition to or instead of these similarity search methods.

Output corrector 508 may select a corrected category embedding 570 from reference embeddings 568 which is similar to or most similar to output category embedding 566 based on the similarity search. For example, corrected category embedding 570 may be a neighbouring vector (e.g. close or closest vector) to output category embedding 566 in the embedding space. Corrected category embedding 570 may, for example, be determined by a nearest neighbour or approximate nearest neighbour search. In some implementations, output corrector 508 may select a corrected category embedding 570 which is most similar to output category embedding 566 relative to the other reference embeddings 568 based on the similarity search. In other implementations, output corrector 508 may not select a corrected category embedding 570 which is most similar to output category embedding 566 relative to the other reference embeddings 568 based on the similarity search. Instead output corrector 508 may instead select a corrected category embedding 570 which is at least similar to output category embedding 566 but also satisfies some other criteria. For example, other constraints in addition to semantic similarity may be used to select corrected category embedding 570, including heuristics, input 542 (e.g. input prompt 542a), etc.

In the depicted example, corrected category embedding 570 is the vector “[0.8, 0.7, 0.1, . . . , 0.2, 0.9]”, which was determined to be similar to the vector “[0.8, 0.6, 0.2, . . . , 0.1, 0.7]” for output category embedding 566. In other words, output category 544 associated with output category embedding 566 may be semantically similar to the valid category associated with corrected category embedding 570. It will be understood that other values for corrected category embedding 570 may also be possible.

As noted above, each of reference embeddings 568 may be associated with one of valid categories 558. To determine corrected category 546, output corrector 508 may select the valid category within valid categories 558 that is associated with corrected category embedding 570. It will be recalled that corrected category embedding 570 was selected from reference embeddings 568. In other words, corrected category 546 may correspond to the valid category in valid categories 558 associated with corrected category embedding 570 selected from reference embeddings 568.

In the depicted example, corrected category 546 may be “Automobiles>Luxury Automobiles>Sports Cars”. It will be appreciated that corrected category 546 may be semantically similar to output category 544, which specifies “Automobiles>Luxury Cars>Sports Cars”. Other values for corrected category 546 may also be possible.

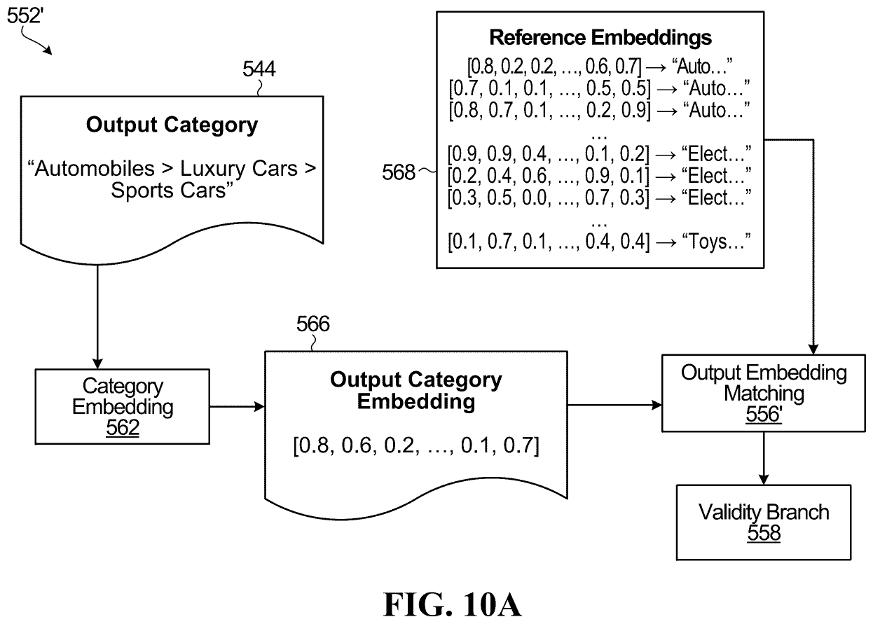

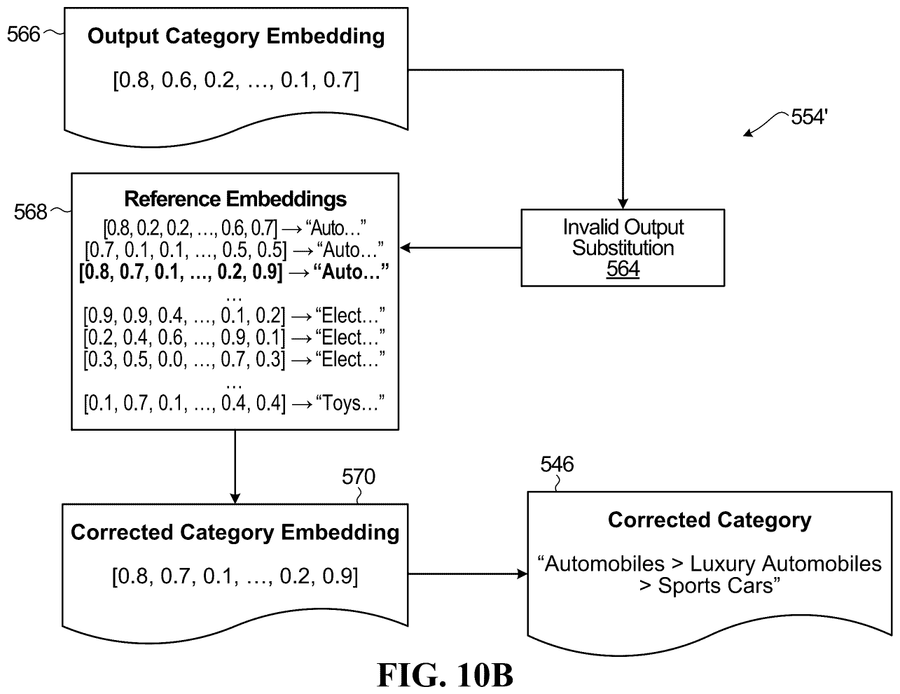

FIG. 10A depicts output validity assessment 552′, which is an alternative example implementation of output validity assessment 552. While performing output validity assessment 552′, output corrector 508 may first perform category embedding 562.

In particular, rather than performing category embedding 562 while performing valid output substitution 554, output corrector 508 may perform category embedding 562 to generate output category embedding 566 while performing output validity assessment 552′. Output validity assessment 552′ may be otherwise identical to output validity assessment 552.

Unlike output matching 556 which performs output matching based on output category 544, output corrector 508 may perform output embedding matching 556′ based on output category embedding 566.

While performing output embedding matching 556′, output corrector 508 may compare output category embedding 566 to reference embeddings 566, rather than to valid embeddings 558. Output corrector 508 may determine whether output category embedding 566 matches any of reference embeddings 568.

Reference embeddings 568 and valid categories 558 may have been obtained using the methods already described herein.

If output corrector 508 determines that output category embedding 566 matches (or, in some implementations, closely matches) any of reference embeddings 568, output corrector 508 may determine that output category 544 associated with output category embedding 566 is valid.

However, if output corrector 508 determines that output category embedding 566 does not match any of reference embeddings 568, output corrector 508 may determine that output category 544 associated with output category embedding 566 is invalid.

In other implementations of output validity assessment 552′, output corrector 508 may perform output matching 556 based on output category 544 instead of output embedding matching 556′ based on output category embedding 566, even though output category embedding 566 may have already been generated.

As already described above, after performing output embedding matching 556′, output correct 508 performs validity branch 560 to proceed depending on whether output category 544 was determined to be valid or invalid.

If output category 544 is determined to be valid while performing output matching 556, output corrector 508 may proceed directly from validity branch 560 to output, bypassing valid output substitution. Output corrector 508 may return output category 544 without any substitution. Output corrector 508 may also output an indication that output category 544 is valid.

However, if output category is determined to be invalid while performing output matching 556, output corrector 508 may proceed to valid output substitution. In some implementations, at this time output corrector 508 may output an indication that output category 544 is invalid. In other implementations, output corrector 508 may only output this indication once it has corrected output category 544.

FIG. 10B depicts valid output substitution 554′, which is an alternative example implementation of valid output substitution 554. Unlike valid output substitution 554, valid output substitution 554′ does not include performing category embedding 562 because category embedding 562 has already been performed in output validity assessment 552. In particular output corrector 508 has already obtained or generated output category embedding 566 before performing valid output substitution 554′, and so output corrector may not need to perform category embedding 562 again.

In some implementations, invalid output substitution 564 and output embedding matching 556′ may be performed at the same time, such that the validity of output category 544 and a similarity search of output category embedding 566 may be established at the same time.

Valid output substitution 554′ may be otherwise identical to valid output substitution 554.

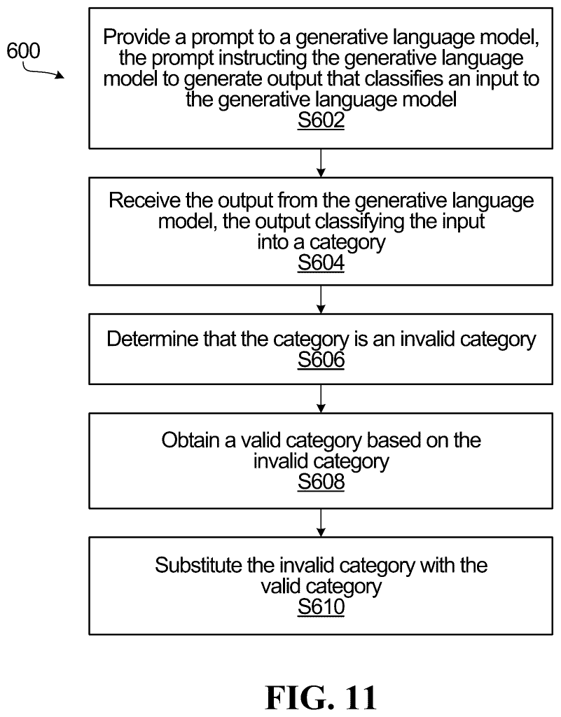

FIG. 11 illustrates a computer-implemented method 600, according to one implementation. Method 600 may be performed by at least one processing unit, which might or might not be distributed. For example, the at least one processing unit may be one or more processors 504, may be a combination of one or more processors 504 and/or one or more other processing units.

At step S602, a prompt is provided to a generative language model. The prompt instructs the generative language model to generate output that classifies an input to the generative language model.

For example, an input may be input 542. In some examples, the input may be an image or some other input data, such as image 542b. The input prompt may be input prompt 542a.

In one specific example, the input to the generative language model may be image 542b, which depicts a sports car.

In other examples, the input may include one or more types of data, such as an image, text, videos, and other data formats. The input may or may not include an image.

Generative language model may be generative language model 506. In some implementations, generative language model 506 may be an LLM.

Generative language model 506 may be instructed by input prompt 542a to generate an output that classifies input 542 or, in an example, classifies image 542b.

Input prompt 542a may specify some or all of the possible categories into which generative language model 506 can classify input 542, such as input image 542b. For example, input prompt 542a may specify example categories “Automobiles>Utility Automobiles>Trucks”, “Automobiles>General Automobiles>Sedans” and “Automobiles>Luxury Automobiles>Sports Cars”, etc. Instead, input prompt 542a may specify non-hierarchical categories, such as “Automobiles”, “Sedans”, “Sports Cars”, etc. In other examples, input prompt 542a may instead or in addition specify the taxonomy “Automobiles” into which generative language model 506 should categorize input 542, such as input image 542b.

However, in other implementations, input prompt 542a may not specify possible categories into which generative language model 506 can categorize input 542, such as input image 542b.

It will be appreciated that the term “classify” as used herein may include “categorize”, “describe”, “respond to” or any other form of output generation performed by the generative language model in which the generative language model is performing a classification related to an input to the generative language model.

At step S604, output is received from the generative language model. The output classifies the input into a category.

In an example, generative language model may be generative language model 506. Generative language model 506 may generate output, such as output category 544.

In one particular example, output category 544 may be “Automobiles>Luxury Cars>Sports Cars”.

In some examples, output category may be hierarchical. In the example where output category 544 is “Automobiles>Luxury Cars>Sports Cars”, output category 544 is hierarchical. “Automobiles” defines the parent category, then “Luxury Cars” defines the next child category and “Sports Cars”defines the next child category after that.

In some further examples, output category may be viewed as an n-dimensional tree, wherein each parent category may have up to n child categories, each of which may have a further up to n child categories, etc.

However, in some other examples, output category may not be hierarchical. In another example, output category 544 may simply be “Luxury Cars”.

At step S606, it is determined that the category is an invalid category.

An invalid category may include a category or terminology that is not preferred. In the example where output category 544 is “Automobiles>Luxury Cars>Sports Cars”, the terminology “Luxury Cars” may not be preferred. Instead, the terminology “Luxury Automobiles” may be preferred. An invalid category may be any category that is not on a defined list of valid categories. For example, valid categories may be predefined and a list of the defined valid categories may be used to fine-tune the generative language model. The valid categories may include the subcategory “Luxury Automobiles”. However, despite the fine-tuning, due to hallucination the output category generated by the generative language model may include “Luxury Cars”. “Luxury Cars” is not a valid subcategory and so the category generated by the generative language model is an invalid category. As such, the invalid category may be output category 544.

It will be understood that the terminology “Luxury Cars” may not be preferred when it is a child category to “Automobiles”. This may occur in the example where output category 544 is hierarchical.

However, in some other examples where output category 544 is not hierarchical or even where output category 544 is hierarchical, the terminology “Luxury Cars” may not be preferred regardless of whether it is a child category or not.

In some implementations, output category 544 may be determined to be invalid by comparing output category 544 to a list of valid categories, such as valid categories 558. If a match is found within valid categories 558 for output category 544, it may be determined that output category 544 is valid, i.e. not invalid. In some implementations, even if no match is found but a close match is found within valid categories 558 for output category 544, it may be determined that output category 544 is valid, i.e. not invalid.

If output category 544 is determined to be valid, the subsequent steps in method 600 may not be performed.

However, if no match is found within valid categories 558 for output category 544, it may be determined that output category is invalid.

In other implementations, output category 544 may be determined to be invalid without reference to a list of valid categories. For example, output category 544 may be determined to invalid by performing a calculation on output category 544.

In some examples, a checksum may be computed from output category 544, and if the checksum is within or outside of a certain value range, it may be determined that output category is valid or invalid.

Other calculations or computations based on output category 544 may also be performed to determine that output category 544 is invalid.

As well, other methods for determining that output category 544 is invalid may also be used.

In some further implementations where output category 544 is hierarchical, such as in the depicted example, the invalid category may only be the unpreferred terminology or sub-category. In the depicted example, the invalid category may only be the sub-category “Luxury Cars”.

At step S608, a valid category may be obtained based on the invalid category.

As discussed above with respect to the example output category 544 (“Automobiles>Luxury Cars>Sports Cars”), the terminology “Luxury Cars” may not be preferred. A valid category may be selected which uses preferred terminology instead of “Luxury Cars”, such as “Luxury Automobiles”.

A valid category may be selected from a list of valid categories, such as valid categories 558. In some implementations, a valid category may be selected by performing a similarity search of valid categories 558 to select a valid category which is most similar to output category 544. “Similar to” may refer to semantic similarity, such that the meaning between the output category 544 and the selected valid category from valid categories 558 is high.

In some other implementations, the similarity search may only select a valid category in valid categories 558 which is similar to output category 544 but not necessarily most similar to output category 544. For example, other factors beyond semantic similarity may be considered in the selection process, such as heuristics, the input (e.g. input 542) to the generative language model (e.g. generative language model 506), etc.

In other implementations, and wherein output category 544 is hierarchical (such as in the depicted example), a valid sub-category may be selected from the list of valid categories. The list of valid categories may include a list of valid sub-categories. It will be appreciated that valid sub-categories may include valid non-hierarchical categories. The selected valid sub-category may be semantically similar to the unpreferred terminology or sub-category in output category 544. For example, a valid sub-category “Luxury Automobiles” could be selected because it is semantically similar to the unpreferred terminology or sub-category “Luxury Cars” in output category 544.

In some further implementations, a valid category may be selected by comparing each of valid categories 558 to the invalid category (output category 544) as strings or sub-strings. A valid category may be selected as a string which has the smallest edit distance from the invalid category, such as output category 544. In other examples, the valid category may be selected based on the edit distance from the invalid category as well as other factors depending on the application.

In other implementations, the invalid category (output category 544) may be fed into another generative language model, which may be instructed to select a valid category. Alternatively or in addition, the input, such as input image 542b may be fed into this other generative language model. This generative language model may be slightly different than generative language model 506, so the second generative language model may properly category the input. As well, second generative language model may be more likely to properly categorize the input if it is provided with the invalid category and instructed that this category is invalid.

Other methods for selecting the valid category may also be possible.

At step S610, the valid category is substituted with the invalid category.

In the example where the invalid category is output category 544, output category 544 may be substituted with the valid category selected from valid categories 558. As noted above, the selected valid category was selected because it is semantically similar to output category 544.

In some implementations, substituting the valid category with the invalid category may include substituting the valid category with the invalid category as the output from the generative language model. For example, the valid category, such as corrected category 546, may substitute the invalid category, such as output category 544, as output from the generative language model 506. The output from generative language model 506 may be modified to substitute the invalid category, such as output category 544, with corrected category 546.

In some other implementations, where the invalid category is only a sub-category within output category 544, only the sub-category within output category 544 may be substituted with the valid category selected from valid categories 588. For example, if a middle sub-category is incorrect in the output, the method described herein may correct that incorrect sub-category the same way as if a child sub-category were incorrect.

In some further implementations, optimization may also be possible if the method caches the output, the corrected output or any other intermediate data, such as embeddings. For example, the method 600 may also cache the invalid category and the selected valid category. If that invalid category appears again, it may be immediately replaced with the corresponding valid category from the cache, thus reducing latency and computational resources for common errors.

As is described herein in detail, an output category embedding may also be generated for the invalid category. This embedding may be cached in addition to or instead of the invalid category. Similarly, the reference embedding for the selected valid category may be cached in addition to or instead of the selected valid category.

In some other implementations, in cases where output category 544 is hierarchical and includes many sub-categories, method 600 may iterate through a plurality of sub-strings which together form output category 544. Iteration may also occur in cases where the number of sub-categories in output category 544 is very large. For example, at step S606, method 600 may iterate through each sub-string and determine whether those sub-strings are valid categories. In some examples, each sub-string may include one category or sub-category. In other examples, each sub-string may include one or more than one category or sub-category.

In these particular implementations, it will be understood that if the output is hierarchical, iterating may match a sub-string (e.g. a sub-category) to a sub-category belonging to a different parent node, thus identifying the sub-string or sub-category as valid when it may actually be invalid. To avoid misidentifying a sub-category as valid while iterating, method 600 may also consider the parent sub-strings or sub-categories while matching the child sub-string or sub-categories to determine validity. Other techniques for avoiding this misidentification may also be possible.

In some other implementations, steps S608 and S610 may also be executed iteratively. For example, if step S606 determines that a sub-string of output category 544 representing one or more categories is invalid, steps S608 may obtain one or more valid categories or valid sub-categories for that sub-string and substitute the invalid sub-string in output category 544 with those one or more valid categories or valid sub-categories.

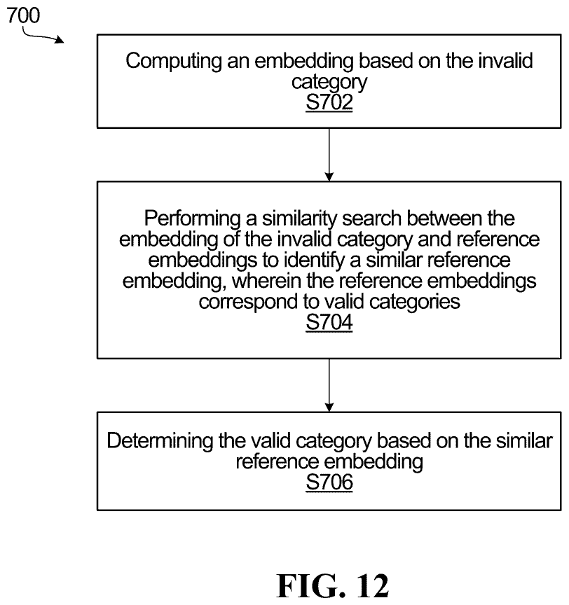

FIG. 12 illustrates a computer-implemented method 700 for performing step S608 for obtaining a valid category based on the invalid category, according to one implementation. Method 700 may be performed by at least one processing unit, which might or might not be distributed. For example, the at least one processing unit may be one or more processors 504, may be a combination of one or more processors 504 and/or one or more other processing units.

At step S702, an embedding is computed based on the invalid category.

As discussed above, an embedding may be computed using a text-to-vector translation. Embedding may allow semantically similar values to be compared to one another.

In the example where the invalid category is output category 544 (“Automobiles>Luxury Cars>Sports Cars”), an output category embedding such as output category embedding 566 may be computed. Output category embedding 566 may also be referred to as the embedding of the invalid category. In the depicted example, output category embedding 566 (i.e. embedding of the invalid category) may be the vector “[0.8, 0.6, 0.2, . . . , 0.1, 0.7]”.

However, it will be understood that other embedding values may be possible, depending on the specific embedding process used, as well as the vector dimensionality, weightings, etc.

At step S704, a similarity search is performed between the embedding of the invalid category and reference embeddings to identify a similar reference embedding, wherein the reference embeddings correspond to valid categories.

Continuing with the example above, the invalid category may be output category 544.

Reference embeddings may be stored in a list, table, array, file database or some other data structure containing embeddings. For example, reference embeddings may be reference embeddings 568.

Each of reference embeddings 568 are associated with one of valid categories 558. For example, reference embeddings 568 and valid categories 558 may be stored in the same data structure or may be associated with one another in memory, such as associated in one or more databases, using memory pointers, etc.

A similarity search is performed between the embedding of the invalid category and the reference embeddings to identify a similar reference embedding to the embedding of the invalid category. In the example where the invalid category is output category 544 and the corresponding embedding is output category embedding 566, the similarity search may be performed using output category embedding 566 and reference embeddings 568.

In some implementations, the similarity search may determine a similar reference embedding within reference embeddings 568 that is most similar to output category embedding 566.

In other implementations, the similarity search may determine a similar reference embedding within reference embeddings 568 that is similar to but not necessarily most similar to output category embedding 566. For example, other factors or criteria may be considered in addition to the similarity search to select a similar reference embedding from reference embeddings 568.

In the depicted example, the similarity search may determine corrected category embedding 570 as the similar reference embedding, which may be the vector “[0.8, 0.7, 0.1, . . . , 0.2, 0.9]”.

The similarity search may include at least one of a vector similarity search, k-nearest neighbour matching, approximate nearest neighbour search, cosine similarity or dot product method. One or more similarity search methods may be used and assessed at step S704. Other similarity search methods may also be used in addition to or instead of these similarity search methods.

At step S706, the valid category is determined based on the similar reference embedding, e.g. by mapping the reference embedding back to its corresponding text representing the valid category.

As noted above, a similar reference embedding may be selected from reference embeddings 568 based on the similarity search at step S704. As well, reference embeddings 568 are associated with valid categories 558. The association between reference embeddings 568 and valid categories 558 may be used to determine the valid category associated with the similar reference embedding.

In the example discussed above where the similar reference embedding is corrected category embedding 570 (“[0.8, 0.7, 0.1, . . . , 0.2, 0.9]”), the corresponding valid category may be corrected category 546. In the example, corrected category 546 may be “Automobiles>Luxury Automobiles>Sports Cars”.

Other values for the valid category may also be possible.

In some alternate implementations, the valid category may actually be a sub-category. This may occur where output category 544 is hierarchical and only a sub-category was determined to be invalid. In these implementations, the similar reference embedding may be associated with a valid sub-category.

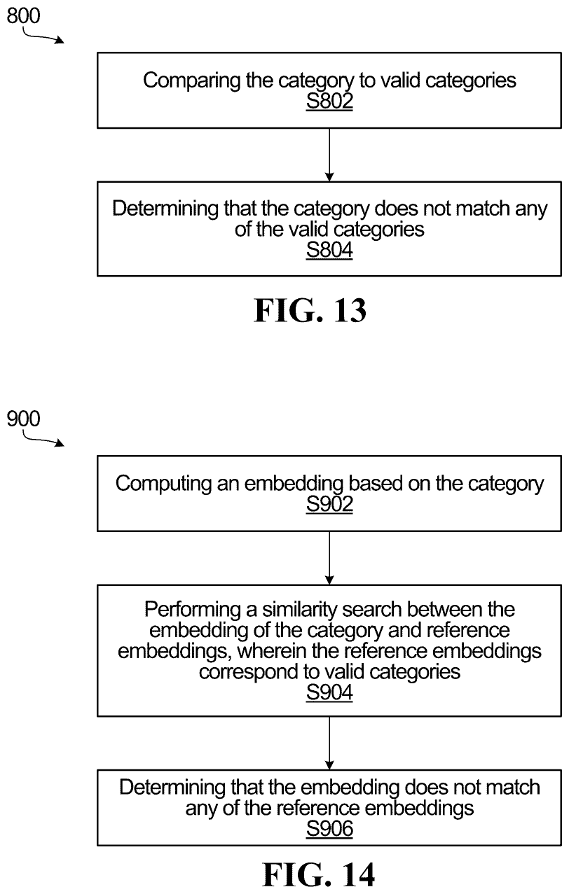

FIG. 13 illustrates a computer-implemented method 800 for performing step S606 for determining that the category is an invalid category. Method 800 may be performed by at least one processing unit, which might or might not be distributed. For example, the at least one processing unit may be one or more processors 504, may be a combination of one or more processors 504 and/or one or more other processing units.

At step S802, the category is compared to valid categories.

In the depicted example, the category may be output category 544.

The valid categories may be valid categories 558, which may be obtained using one or more of the methods discussed above.

Output category 544 may be compared to valid categories 558 by iterating through each of valid categories 558 until a match is found between output category 544 and one of valid categories 558. If no match is found, output category 544 may be compared to each of valid categories 558, i.e. this may include iterating through each of valid categories 558.

In other implementations, instead of iterating through valid categories 558, valid categories may be selected at random and compared with output category 544 until a match is found. After testing a certain number of valid categories 558 (such as the entire length of valid categories 558 or some multiple of this length), it may be determined that no match is found.

In further implementations, some form of a binary search or other search algorithm may be used to compare output category 544 to valid categories 558. For example, the first, last and middle valid categories 558 may be compared to valid category first. Based on some metric from this comparison, such as a metric indicating character similarity (a certain number or length of substrings within a specific valid category match some substrings within output category 544), the method may determine where to continue the search.

At step S804, it is determined that the category does not match any of the valid categories.

A match may be determined by performing a string compare between output category 544 and one of valid categories 558. If the string compare determines that the string or text of output category 544 is the same as the string or text of the one of valid categories 558, then a match may have been found. If the strings or text are not the same, then the method may test the next of valid categories 558 against output category 544.

In some alternative implementations, rather than checking for a match between the full text or string of output category 558 and the one of valid categories 558, only a partial match may need to be determined. For example, if a certain length of substring within one or output category 558 is found to match a string or substring within the one of valid categories 558 (or vice versa), then a match or sufficient-enough match may have been found.

In some further examples, a match between output category 544 and one of valid categories 558 may be determined by computing a value based on output category 544 and computing another value based on the one of valid categories 558 into some. A match may be determined if the two computed values match. A match may also be determined if the two computed values are within a specified range.

It will be appreciated that other methods for determining a match may also be used.

As already discussed above, output category 544 may be compared against each of valid categories 558. If no match is found between output category 544 and any of valid categories 558, then it may be determined that output category 558 does not match any of valid categories 558. This may occur after iterating through each of valid categories 558 or performing enough comparisons between valid categories 558 and output category 544 that the method is satisfied there is no match.

If there is no match found between output category 544 and valid categories 558, it may be determined that output category 558 is invalid.

FIG. 14 illustrates an alternate computer-implemented method 900 for performing step S606 for determining that the category is an invalid category. Method 900 may be performed by at least one processing unit, which might or might not be distributed. For example, the at least one processing unit may be one or more processors 504, may be a combination of one or more processors 504 and/or one or more other processing units.

At step S902, an embedding is computed based on the category.

As discussed above, an embedding may be computed using a text-to-vector translation. Embedding may allow semantically similar values to be compared to one another.

In the example where the category is output category 544 (“Automobiles>Luxury Cars>Sports Cars”), an output category embedding such as output category embedding 566 may be computed. Output category embedding 566 may also be referred to as the embedding of the category. In the depicted example, output category embedding 566 (i.e. embedding of the invalid category) may be the vector “[0.8, 0.6, 0.2, . . . , 0.1, 0.7]”.

However, it will be understood that other embedding values may be possible, depending on the specific embedding process used, as well as the vector dimensionality, weightings, etc.

At step S904, a similarity search is performed between the embedding of the category and reference embeddings, wherein the reference embeddings correspond to valid categories.

Continuing with the example above, the category may be output category 544.

Reference embeddings may be stored in a list, table, array, file database or some other data structure containing embeddings. For example, reference embeddings may be reference embeddings 568.

Each of reference embeddings 568 are associated with one of valid categories 558. For example, reference embeddings 568 and valid categories 558 may be stored in the same data structure or may be associated with one another in memory, such as associated in one or more databases, using memory pointers, etc.

A similarity search is performed between the embedding of the category and the reference embeddings to identify a matching reference embedding to the embedding of the category. In the example where the category is output category 544 and the corresponding embedding is output category embedding 566, the similarity search may be performed using output category embedding 566 and reference embeddings 568.

In some implementations, the similarity search may determine a reference embedding within reference embeddings 568 that matches output category embedding 566.

In other implementations, the similarity search may determine a similar reference embedding within reference embeddings 568 that is similar to but not identical to (i.e. not matching) output category embedding 566. For example, other factors may be considered in addition to the similarity search to select a “matching” (or near matching) reference embedding from reference embeddings 568.

The similarity search may include at least one of a vector similarity search, k-nearest neighbour matching, approximate nearest neighbour search, cosine similarity or dot product method. One or more similarity search methods may be used and assessed at step S904. Other similarity search methods may also be used in addition to or instead of these similarity search methods.

In some implementations, output category embedding 566 may be compared to each of reference embeddings 568 to determine if there is a match or a sufficient match. This may be done using one of the similarity search methods described above.

The comparison may involve iterating through each of reference embeddings 568 in order, performing a binary search or performing some other method to compare output category embedding 566 to reference embeddings 568. This comparison, including what kind of iteration is used, may be dictated by the similarity search method.

It will also be appreciated that output category embedding 566 may not be compared to every single one of reference embeddings 568, depending on the similarity search method used. The method may determine that output category embedding 566 does not match or does not sufficiently match any of reference embeddings 568 without needing to compare output category embedding 566 to each of reference embeddings 568. For example, if reference embeddings 568 are ordered in some specific way and output category embedding 566 does not match those reference embeddings appear in a certain portion of the ordered reference embeddings 568 (e.g. the first reference embedding), the method may be able to determine that output category embedding 566 may not match or sufficiently match any of the other reference embeddings 566.

At step S906, it is determined that the embedding does not match any of the reference embeddings.

As noted above, a matching reference embedding may be selected from reference embeddings 568 based on the similarity search at step S904. As well, since reference embeddings 568 are associated with valid categories 558, if a matching reference embedding is found, then the category (e.g. output category 544) may also be valid. However, if no match is found, then output category 544 may be invalid.

It may be determined that no match is found after the similarity search at step S904 completes without finding a match. For example, if each of reference embeddings 568 is compared to output category embedding 566 and no match is found, then this may be sufficient to determine that the output category embedding 566 does not match any of reference embeddings 568.

In other implementations, however, and as already discussed above, it may be sufficient to know that output category embedding 566 does not match some of reference embeddings 568 to know that output category embedding 566 also does not match any of reference embeddings 568. This may occur, for example, where reference embeddings 568 are ordered.

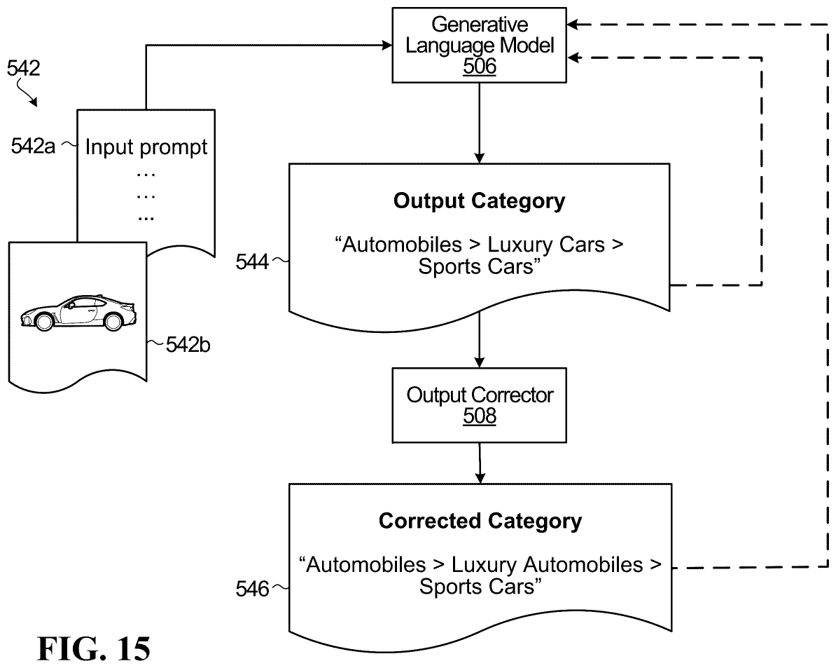

FIG. 15 depicts another example of applying system 500. In the depicted example, output category 544 generated by generative language model 506 and corrected category 546 generated by output corrector 508 may be fed back into generative language model 506 for retraining of generative language model 506.

In addition, input 542 may also be fed back into generative language model 506 for retraining generative language model 506. In the depicted example, input 542 may include image 542b and input prompt 542a. However, it will be appreciated that input 542 may also include other data types or data input in addition to or instead of image 542b.

It will be understood that retraining generative language model 506 may include fine turning generative language model 506.

A retraining algorithm and/or fine-tuning algorithm may be used to retrain (e.g. fine tune) generative language model 506 based on at least one of output category 544, corrected category 546 and input 542 (e.g. input image 542b and input prompt 542a). Methods may include supervised fine-tuning, such as hyperparameter tuning, transfer learning, multi-task learning, few-shot learning, or task-specific fine-tuning. Methods may also include reinforcement learning, or any other fine-tuning and/or re-training methods.

The example of applying system 500 depicted in FIG. 16 may be otherwise identical to the example depicted in FIG. 7.

Technical benefits of some implementations described herein are as follows. Note that the technical benefits described below assume the generative language model is an LLM, but the explanation and described benefits equally apply more generally to a generative language model.

An LLM generates output that classifies an input to the LLM. The input may be text, an image or some combination of input types. However, the LLM may hallucinate, generating an output category which may either be incorrect or, although correct, may not conform to a preferred terminology or category.

For example, the LLM may be asked to generate a textual description of an input. The input may be an image depicting a shoe kicking a ball. The LLM may even be provided with additional textual instruction that the image depicts a type of sport and that the LLM should describe what the sport depicted in the image. The LLM may generate the output “a soccer shoe kicking a ball”. However, although the output from the LLM may be understandable to a human, the preferred terminology (i.e. valid categorization) may be “a football shoe kicking a ball”. The LLM may have hallucinated and produced the output “soccer”instead of “football”.

In a further example of the technical problem, the LLM may be provided with this same image depicting a shoe kicking a ball but may instead be asked to categorize what is depicted within the image. The LLM may generate the output “Leisure>Sports>Soccer”. Although the output category from the LLM may be understandable to a human, the preferred category (i.e. valid category) may be “Leisure>Sports>Football”. It will be appreciated that the output category here may also be hierarchical, such that “Sports” is a sub-category of “Leisure” and “Football” is a sub-category of “Sports”. The LLM may have hallucinated and produced “Leisure>Sports>Soccer” instead of “Leisure>Sports>Football”.

In another example, the LLM may be prompted with a user query, such as the query “Which direction is the bus terminal on the map?” The LLM may be configured to respond to the user query with one or more predefined answers. However, in some cases the LLM may still hallucinate and generate a response that is not included within the predefined answers. For example, rather than responding with the output “East”, the LLM may hallucinate and instead respond with the invalid output “Right”.

One method of addressing this technical problem of hallucination may be to enforce a grammar at the LLM's output as it generates each token to limit output only to valid strings, and thus only to valid output categories. However, as discussed above, implementing these grammars may be computationally expensive.

The methods and systems described herein perform semantic replacement at the output of the LLM, reducing the consumption of computational resources. For example, in situations where the category is hierarchical, the methods and systems described herein do not require significant processing upfront. Rather, the category output from the LLM is checked to determine whether it is valid or not. This may involve comparing the output category to a list of valid categories, or it may involve some computation on the output category itself, such as a checksum, etc. For example, if the output category is determined to be invalid, the invalid category is substituted with a valid category from the list of valid categories that is similar to it (e.g. most similar to it or just similar to it and also satisfying some other heuristics). This process consumes fewer computing resources than other methods which may involve constraining token prediction by the LLM, especially when the output is hierarchical.

In this way, operation of the computer for performing classification using an LLM is improved compared to conventional operation, not by additional training/fine-tuning (although this could be implemented) and not by enforcement of grammars on the output of the LLM, which as explained above may be computationally expensive and/or may have the other drawbacks explained earlier. Instead, the improvement is achieved by implementing the semantic replacement method described herein.

Moreover, if the category is determined to be valid by the methods and systems described herein, the semantic replacement step does not need to execute, reducing latency, memory and processor usage. Instead, the output from the LLM may be used for subsequent processing, bypassing the semantic replacement step. This further saves computer operations because the semantic replacement step only needs to be performed when there is hallucination resulting in an invalid category, rather than all the time.

In addition to reducing computing resources, the method herein may also be used improve the accuracy of the output category generated by the LLM. Rather than just ensuring that the LLM selects tokens which are specified in a grammar file, the methods and systems described herein correct the output category generated by the LLM based on semantics. For example, if the output category is determined to be invalid (e.g. the output category does not match one of several valid categories), the method may use an embedding of the output category to determine a valid category that is more appropriate. The embedding is a vector which may capture the semantic meaning of the output category. This embedding may be compared to a list of reference embeddings, each of which may correspond to a valid category. A similarity search method may be used to find the reference embedding most similar to the embedding of the invalid output category. Since this most similar reference embedding is associated with a valid category, the invalid category output from the LLM may be substituted with this valid category. This process may ensure that the valid category which substitutes the invalid output category is both semantically similar to the invalid category but also valid (e.g. uses preferred terminology or category/sub-category names).

In further examples, rather than selecting the most similar reference embedding, a similar reference embedding that is not the most similar of the reference embeddings may be selected. This selection may consider other factors beyond similarity, such as heuristics and the input to the LLM (e.g. additional constraints). It will be appreciated that, unlike the method describe herein, other methods which constrain token prediction by the LLM may be unable to consider these additional factors.

The methods and systems described herein may also be used in combination with other strategies for reducing hallucination in generative language models (e.g. LLMs). For example, grammar enforcement may be used at the output of an LLM in addition to the methods and system described herein.

Additionally, the methods and systems described herein may help determine whether certain inputs and/or outputs to the LLM require improvement. For example, the LLM may need to be trained, retrained or fine tuned on additional data to properly categorize these inputs and avoid hallucinating. The methods and systems described herein may be used to identify these inputs and outputs. For example, if an output category is determined to be invalid by the method, the input, the invalid output category, and/or the selected valid category may be considered to determine training data to further fine tune the LLM. This input, invalid output category and/or selected valid category may all be used as training data to retrain the LLM, including for fine tuning. In addition, a differential between the selected valid category and the invalid output category may also be used to fine tune the model, such as taking a difference between the embeddings of these two categories. As such, in addition to the technical benefits related to correcting hallucination once it has occurred in the LLM's output, the methods and systems described herein may be used to improve the LLM overall. Inputs and outputs may be fed back into the LLM in a feedback loop to identify aspects of the model requiring improvement and to retrain or fine tune the model accordingly. As such, the methods and systems described herein may also improve the functioning of the trained LLM.

Additionally, the methods and systems described herein may be further improved by caching invalid output categories from the LLM, as well as the valid categories used to replace those invalid categories. This caching of common errors may be used reduce latency and computational resources.

It will also be appreciated that the methods and systems described herein may be agnostic of the type of LLM used to generate the output. The methods and systems may thus be applied to a variety of different generative language models, which may be treated as a “black box”. As well, the LLM or generative language models may generate output locally or remotely from the methods and systems described herein, as already described above.

### Conclusion

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

Memory, as used herein, may refer to memory that is persistent (e.g. read-only-memory (ROM) or a disk), or memory that is volatile (e.g. random access memory (RAM)). The memory may be distributed, e.g. a same memory may be distributed over one or more servers or locations.

1. A computer-implemented method comprising:
providing a prompt to a generative language model, the prompt instructing the generative language model to generate output that classifies an input to the generative language model;
receiving the output from the generative language model, the output classifying the input into a category;
determining that the category is an invalid category;
obtaining a valid category based on the invalid category; and
substituting the invalid category with the valid category.

2. The computer-implemented method of claim 1, wherein obtaining the valid category based on the invalid category comprises:
computing an embedding based on the invalid category;
performing a similarity search between the embedding of the invalid category and reference embeddings to identify a similar reference embedding, wherein the reference embeddings correspond to valid categories; and
determining the valid category based on the similar reference embedding.

3. The computer-implemented method of claim 2, wherein performing the similarity search comprises at least one of: a vector similarity search, k-nearest neighbour matching, approximate nearest neighbour search, cosine similarity or dot product method.

4. The computer-implemented method of claim 1, wherein determining that the category is an invalid category comprises:
comparing the category to valid categories; and
determining that the category does not match any of the valid categories.

5. The computer-implemented method of claim 4, wherein determining that the category is an invalid category further comprises:
computing an embedding based on the category;
performing a similarity search between the embedding of the category and reference embeddings, wherein the reference embeddings correspond to valid categories; and
determining that the embedding does not match any of the reference embeddings.

6. The computer-implemented method of claim 1, further comprising further fine tuning the generative language model using at least one of: the valid category, the invalid category, a differential between the valid category and the invalid category, or the input to the generative language model.

7. The computer-implemented method of claim 1, further comprising determining training data to fine tune the generative language model based on at least one of: the valid category, the invalid category, or the input to the generative language model.

8. The computer-implemented method of claim 1, wherein the invalid category is expressed by the generative language model as a list having sub-categories hierarchically arranged relative to one another.

9. The computer-implemented method of claim 8, wherein determining that the category is an invalid category includes determining that at least one of the sub-categories is an invalid sub-category.

10. The computer-implemented method of claim 9, wherein substituting the invalid category with the valid category comprises substituting the at least one invalid sub-category with at least one valid sub-category.

11. A system comprising:
at least one processor; and
a memory storing processor-executable instructions that, when executed by the at least one processor, cause the at least one processor to:
provide a prompt to a generative language model, the prompt instructing the generative language model to generate output that classifies an input to the generative language model;
receive the output from the generative language model, the output classifying the input into a category;
determine that the category is an invalid category;
obtain a valid category based on the invalid category; and
substitute the invalid category with the valid category.

12. The system of claim 11, wherein obtaining the valid category based on the invalid category comprises:
computing an embedding based on the invalid category;
performing a similarity search between the embedding of the invalid category and reference embeddings to identify a similar reference embedding, wherein the reference embeddings correspond to valid categories; and
determining the valid category based on the similar reference embedding.

13. The system of claim 12, wherein performing the similarity search comprises at least one of: a vector similarity search, k-nearest neighbour matching, approximate nearest neighbour search, cosine similarity or dot product method.

14. The system of claim 11, wherein determining that the category is an invalid category comprises:
comparing the category to valid categories; and
determining that the category does not match any of the valid categories.

15. The system of claim 14, wherein determining that the category is an invalid category further comprises:
computing an embedding based on the category;
performing a similarity search between the embedding of the category and reference embeddings, wherein the reference embeddings correspond to valid categories; and
determining that the embedding does not match any of the reference embeddings.

16. The system of claim 11, wherein the at least one processor is to fine tune the generative language model using at least one of: the valid category, the invalid category, a differential between the valid category and the invalid category, or the input to the generative language model.

17. The system of claim 11, wherein the invalid category is expressed by the generative language model as a list having sub-categories hierarchically arranged relative to one another.

18. The system of claim 17, wherein determining that the category is an invalid category includes determining that at least one of the sub-categories is an invalid sub-category.

19. The system of claim 18, wherein substituting the invalid category with the valid category comprises substituting the at least one invalid sub-category with at least one valid sub-category.

20. One or more non-transitory computer readable media having stored thereon computer-executable instructions that, when executed by at least one processor, cause the at least one processor to perform a method comprising:
providing a prompt to a generative language model, the prompt instructing the generative language model to generate output that classifies an input to the generative language model;
receiving the output from the generative language model, the output classifying the input into a category;
determining that the category is an invalid category;
obtaining a valid category based on the invalid category; and
substituting the invalid category with the valid category.
